(19) United States
(12) Patent Application Publication
(10) Pub. No.: US 2012/0306854 A1
(43) Pub. Date: Dec. 6, 2012

(54) STORAGE MEDIUM, IMAGE PROCESSING APPARATUS, IMAGE PROCESSING METHOD, AND IMAGE PROCESSING SYSTEM

(75) Inventors: Yoichi Yamada, Kyoto (JP); Shigeyuki Asuke, Kyoto (JP)

(73) Assignee: NINTENDO CO., LTD., Kyoto (JP)

(21) Appl. No.: 13/232,376

(22) Filed: Sep. 14, 2011

(30) Foreign Application Priority Data
Jun. 3, 2011 (JP) 2011-124776

(51) Int. Cl. G06T 15/00

(52) U.S. Cl. 345/419

(57) ABSTRACT

An example of a game apparatus as an image processing apparatus includes a CPU, and the CPU controls a movement, etc. of a player object according to an instruction from a player. In a case that the player object exists within an area in which an enemy object is made to appear, and a set condition is satisfied, an enemy setting tag is set. At this time, the CPU sets the enemy setting tag at a position moved away from a predetermined distance along a course in a moving direction of the player object. That is, an arrangement position of the enemy object is decided. Then, the CPU sets the enemy object according to the enemy setting tag.

### CROSS REFERENCE OF RELATED APPLICATION

The disclosure of Japanese Patent Application No. 2011-124776 filed on Jun. 3, 2011 is incorporated herein by reference.

### FIELD

The present example embodiment relates to a storage medium, image processing apparatus, image processing method and image processing system. More specifically, the present example embodiment relates to a storage medium, image processing apparatus, image processing method and image processing system that arranges and displays objects.

### SUMMARY

Therefore, it is a primary object of the present example embodiment to provide a novel storage medium, image processing apparatus, image processing method and image processing system.

Furthermore, another object of the present example embodiment is to provide a storage medium, image processing apparatus, image processing method and image processing system capable of approximately deciding arrangement positions of objects depending on the situations.

A first example embodiment is a storage medium storing an image processing program, wherein the image processing program causes a computer of an image processing apparatus to function as an image outputter, an arrangement position decider, and an object arranger. The image outputter outputs an image obtained by imaging a virtual space to which a terrain is set with a virtual camera. The arrangement position decider decides an arrangement position of an object on the basis of a parameter which is defined in the terrain and a predetermined referential position. The object arranger arranges the object at the arrangement position decided by the arrangement position decider.

According to the first example embodiment, the arrangement position of the object is decided on the basis of the parameter which is defined in the terrain and the predetermined referential position, and therefore, it is possible to appropriately decide the arrangement position of the object depending on the situations, such as a surrounding environment.

A second example embodiment is according to the first example embodiment, wherein the parameter includes a predetermined point of the terrain, and the arrangement position decider decides a position specified based on a length of a line segment connecting the predetermined point and the referential position as the arrangement position of the object.

According to the second example embodiment, the arrangement position of the object is decided on the basis of the length of the line segment, and therefore, it is possible to appropriately decide the arrangement position of the object in correspondence with the length of the line segment connecting the predetermined point and the referential position.

A third example embodiment is according to the second example embodiment, wherein the arrangement position decider decides, as the arrangement position of the object, a position on another line set so as to form with the line segment an angle decided in correspondence with the length of the line segment with the predetermined point as center.

According to the third example embodiment, it is possible to decide the arrangement position of the object at a position on another line set so as to form with said line segment an angle decided in correspondence with the length of the line segment.

Accordingly, for example, this is suitable for a case that the arrangement position of the object is decided on the curved line defined by a predetermined radius.

A fourth example embodiment is according to the second example embodiment, wherein the arrangement position decider decides, as the arrangement position of the object, an end point of another line set so as to form with the line segment an angle decided in correspondence with a length of the line segment with the predetermined point as center.

According to the fourth example embodiment, it is possible to decide the arrangement position of the object on the basis of the length of the line segment and the angle decided in accordance therewith. Accordingly, this is suitable for a case that an object is arranged on a circumference of a circle with a predetermined radius, such as a circle.

A fifth example embodiment is according to the third example embodiment, wherein the angle is decreased as the length of the line segment is increased.

According to the fifth example embodiment, as the line segment is increased, the angle is decreased, and therefore, in a case that the object is arranged on the curved line having a reference point, it is possible to set the distance between the reference point and the arrangement position of the object on the curved line to be constant irrespective of the length of the line segment.

A sixth example embodiment is according to the second example embodiment, wherein the parameter further includes a height of the terrain.

According to the sixth example embodiment, the arrangement position of the object is decided in consideration of the height of the terrain, and therefore, it is possible to appropriately decide the arrangement position of the object depending on the situations.

A seventh example embodiment is according to the sixth example embodiment, wherein the arrangement position decider decides a position of the terrain with the height having a predetermined relationship with the height at the referential position of the terrain as the arrangement position of the object.

According to the seventh example embodiment, the height of the referential position is further considered, and therefore, it is possible to appropriately decide the arrangement position of the object depending on the situations.

An eighth example embodiment is according to the second example embodiment, wherein the terrain includes a curved course, and the predetermined point of the terrain is a center point for defining the curved course, and a referential position is set to the curved course.

According to the eighth example embodiment, it is possible to appropriately arrange the object in correspondence with the referential position on the curved course. Furthermore, in correspondence with the positional relationship between the center point for defining the curved course and the point on the curve, the arrangement position of the object is decided, and therefore, it is possible to simplify the processing when the arrangement position of the object is set on the course in a curved line.

A ninth example embodiment is according to the eighth example embodiment, wherein the terrain includes a spirally-formed curved course. For example, when the referential position set on the course is changed, the line segment connecting the predetermined point and the referential position is changed, and on the basis thereof, the arrangement position of the object is decided.

According to the ninth example embodiment, it is possible to approximately decide the arrangement position of the object in correspondence with the positional relationship between the predetermined point and the referential position. Furthermore, the arrangement position of the object is decided in correspondence with the line segment connecting the predetermined point and the referential position, that is, the radius of the spirally-formed curved line, and therefore, it is possible to simplify the processing when the arrangement position of the object on the course like a spiral curve with a predetermined radius is decided.

A tenth example embodiment is according to the ninth example embodiment, wherein the spirally-formed curved course changes in height toward a center.

According to the tenth example embodiment, it is possible to appropriately decide the arrangement position of the object in correspondence with the positional relationship in consideration of the height as well. Accordingly, this is suitable for a case that the object is arranged on the course gradually increased (or decreased) in height through the curved course.

An eleventh example embodiment is according to the first example embodiment, wherein the object is a non-player object such as an enemy object and an item object, the referential position is a current position of a player object, and the arrangement position decider decides an arrangement position of the non-player object at a position a predetermined interval away along a current moving direction of the player object.

According to the eleventh example embodiment, it is possible to approximately decide the arrangement position of the non-player object in correspondence with the current position of the player object and the current moving direction.

A twelfth example embodiment is an image processing apparatus comprising an image outputter which outputs an image obtained by imaging a virtual space to which a terrain is set with a virtual camera; an arrangement position decider which decides an arrangement position of an object on the basis of a parameter which is defined in the terrain and a predetermined referential position; and an object arranger which arranges the object at the arrangement position decided by the arrangement position decider.

A thirteenth example embodiment is an image processing method of the image processing apparatus, comprising steps of (a) outputting an image obtained by imaging a virtual space to which a terrain is set with a virtual camera; (b) deciding an arrangement position of an object on the basis of a parameter which is defined in the terrain and a predetermined referential position; and (c) arranging the object at the arrangement position decided by the step (b).

A fourteenth example embodiment is an image processing system comprising steps of an image outputter which outputs an image obtained by imaging a virtual space to which a terrain is set with a virtual camera; an arrangement position decider which decides an arrangement position of an object on the basis of a parameter which is defined in the terrain and a predetermined referential position; and an object arranger which arranges the object at the arrangement position decided by the arrangement position decider.

In the twelfth to fourteenth example embodiments as well, similar to the first example embodiment, it is possible to appropriately decide the arrangement position of the object.

The above described objects and other objects, features, aspects and advantages of the present example embodiment will become more apparent from the following detailed description of the present example embodiment when taken in conjunction with the accompanying drawings.

### BRIEF DESCRIPTION OF THE DRAWINGS

FIG. 1 shows an example non-limiting game system;

FIG. 2 shows an example non-limiting electric configuration of the game system shown in FIG. 1;

FIG. 3 shows an example non-limiting appearance of a first controller shown in FIG. 1;

FIG. 4 shows an example non-limiting appearance of the first controller connected with a gyro unit and the gyro unit, shown in FIG. 1;

FIG. 5 shows an example non-limiting appearance of a second controller shown in FIG. 1;

FIG. 6 shows an example non-limiting state where a player operates the controllers;

FIG. 7 shows an example non-limiting electric configuration in a state where the first controller, the gyro unit and the second controller that are shown in FIG. 1 are connected with each other;

FIG. 8 shows an example non-limiting markers shown in FIG. 1 and viewing angles of the controller;

FIG. 9 shows an example non-limiting imaged images including object images;

FIG. 10 shows an example non-limiting game screen to be displayed on the monitor shown in FIG. 1;

FIG. 11 shows an example non-limiting terrain formed of a plurality of circular curved course as seen from above;

FIG. 12 shows another example non-limiting game screen to be displayed on the monitor shown in FIG. 1;

FIG. 13 shows an example non-limiting terrain formed of a spiral curved course displayed on the game screen shown in FIG. 12 as seen from above and an enemy setting tag setting method in consideration of height;

FIG. 14 shows an example non-limiting memory map of a main memory shown in FIG. 2;

FIG. 15 shows an example non-limiting flowchart showing game entire processing by the CPU shown in FIG. 2;

FIG. 16 shows an example non-limiting flowchart showing enemy arrangement position deciding processing by the CPU shown in FIG. 2; and

FIG. 17 shows another example non-limiting terrain on which an enemy object is made to appear.

### DETAILED DESCRIPTION OF NON-LIMITING EXAMPLE EMBODIMENTS

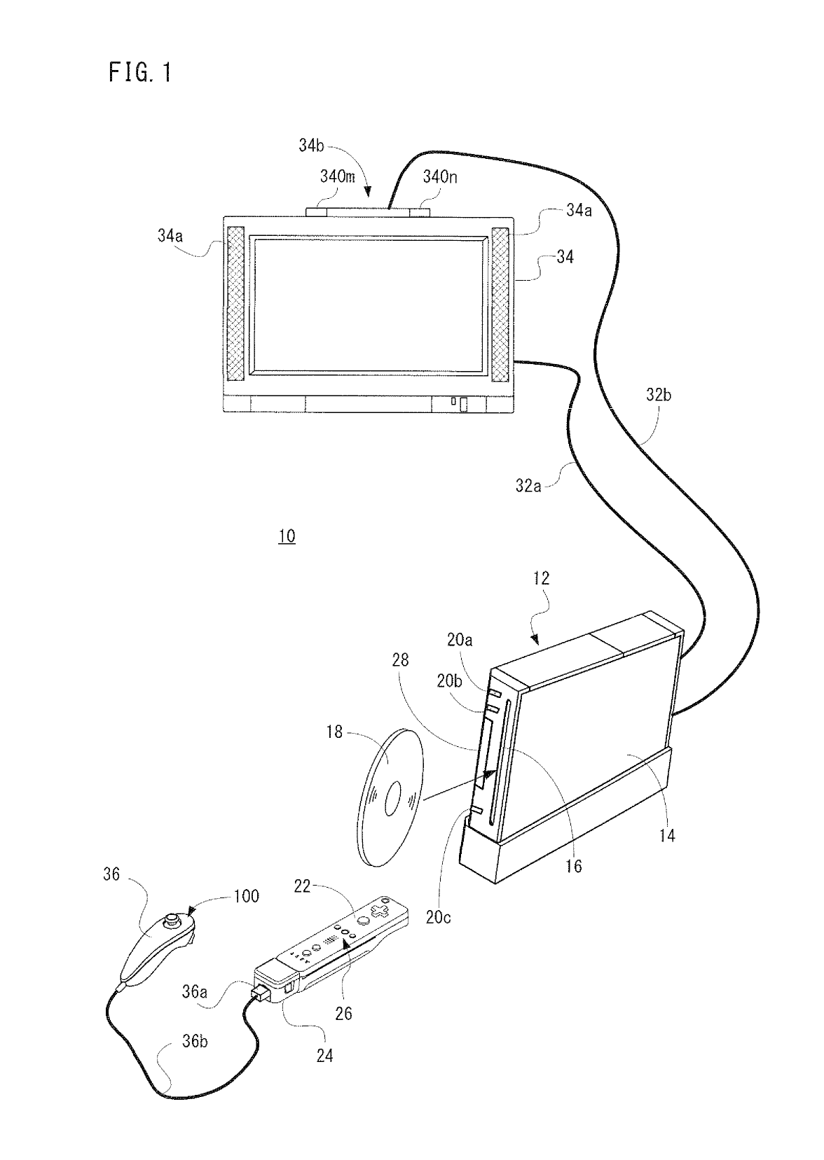

Referring to FIG. 1, a game system 10 of the non-limiting example embodiment includes a video game apparatus (hereinafter, simply referred to as “game apparatus”) 12 functioning as an image processing apparatus and a first controller 22. Although illustration is omitted, the game apparatus 12 of this embodiment is designed such that it can be connected with up to four controllers 22. Furthermore, the game apparatus 12 and the respective controllers 22 are connected by a wireless manner. The wireless communication is executed according to a Bluetooth (registered trademark) standard, for example, but may be executed by other standards such as infrared rays, a wireless LAN. In addition, it may be connected by a wire. Furthermore, in this embodiment, the first controller 22 is connected (coupled) with a gyro unit 24, and the gyro sensor 24 is connected with a second controller 36 via an attachment plug 36a and a cable 36b.

Although illustration is omitted, in a case that the gyro unit 24 is not attached to the first controller 22, the second controller 36 can be connected to the first controller 22 via the attachment plug 36a and the cable 36b.

The gyro unit 24 is couple to the first controller 22 to thereby physically and electrically be connected to the first controller 22. Accordingly, from the gyro unit 24 attached (integrated) to the first controller 22, angular velocity data indicating the angular velocity of the first controller 22 is output and applied to the first controller 22.

Furthermore, operation data or input data of the second controller 36 is applied to the first controller 22 via the cable 36b, the attachment plug 26b and the gyro unit 24.

Accordingly, the first controller 22 transmits to the game apparatus 12 the angular velocity data from the gyro unit 24 and the operation data or the input data from the second controller 36 as well as the operation data or the input data from the first controller 22 itself.

Here, in a case that the gyro unit 24 is not attached to the first controller 22, the operation data or the input data from the second controller 36 is applied to the first controller 22 via the cable 36b and the attachment plug 36a.

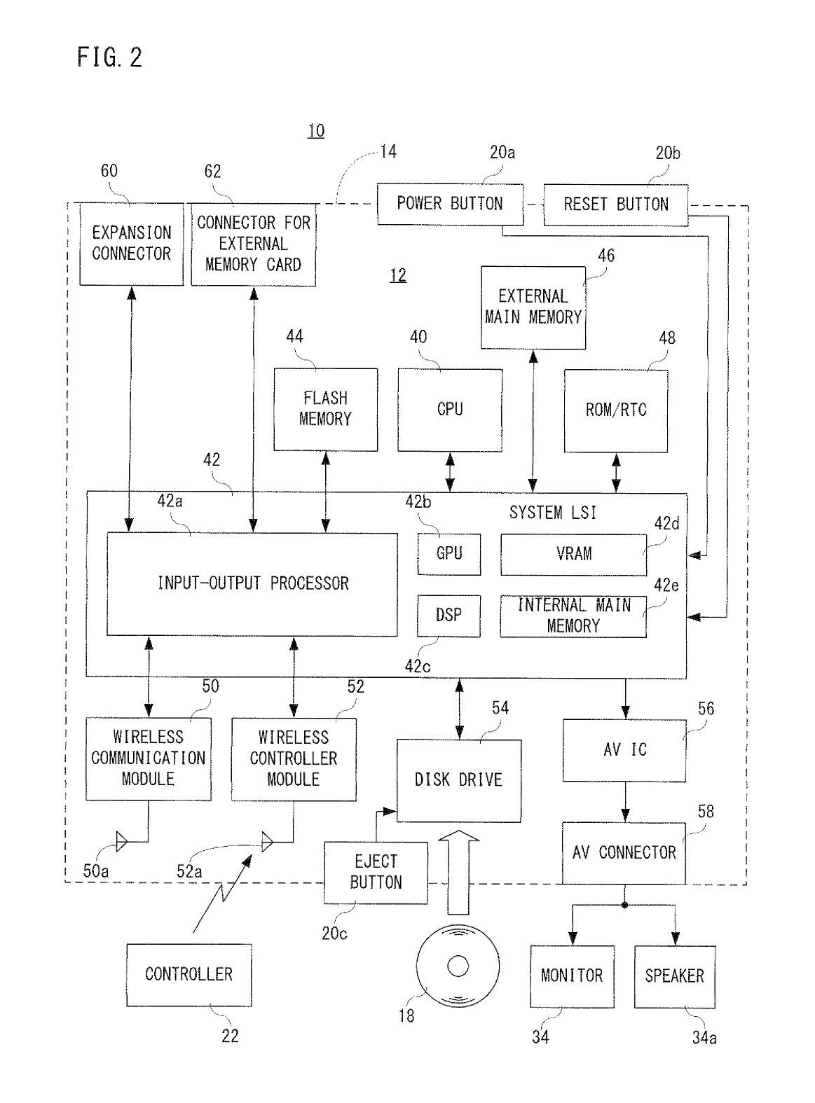

Returning to FIG. 1, the game apparatus 12 includes a roughly rectangular parallelepiped housing 14, and the housing 14 is furnished with a disk slot 16 on a front surface. Through the disk slot 16, an optical disk 18 as one example of an information storage medium storing game program, etc. is inserted to be loaded into a disk drive 54 (see FIG. 2) within the housing 14. Although illustration is omitted, around the disk slot 16, an LED and a light guide plate are arranged such that the LED of the disk slot 16 can light up or blink in accordance with various processing.

Furthermore, on the upper front surface of the housing 14 of the game apparatus 12, a power button 20a and a reset button 20b are provided, and below them, an eject button 20c is provided. In addition, a connector cover for external memory card 28 is provided between the reset button 20b and the eject button 20c, and in the vicinity of the disk slot 16. Inside the connector cover for external memory card 28, a connector for external memory card 62 (see FIG. 2) is provided, through which an external memory card (hereinafter simply referred to as a “memory card”) not shown is inserted. The memory card is employed for loading the game program, etc. read from the optical disk 18 to temporarily store it, storing (saving) game data (result data or proceeding data of the game) of the game played by means of the game system 10, and so forth. It should be noted that storing the game data described above may be performed on an internal memory, such as a flash memory 44 (see FIG. 2) inside the game apparatus 12 in place of the memory card. Also, the memory card may be utilized as a backup memory for the internal memory. In addition, in the game apparatus 12, other applications except for the game may be executed, and in such a case, data of the other applications can be stored in the memory card.

Here, a general-purpose SD card can be employed as a memory card, but other general-purpose memory cards, such as memory sticks, a multimedia card (registered trademark) can be employed.

Although omitted in FIG. 1, the game apparatus 12 has an AV cable connector 58 (FIG. 2) on a rear surface of the housing 14, and by utilizing the AV cable connector 58, a monitor 34 and a speaker 34a are connected to the game apparatus 12 through an AV cable 32a. The monitor 34 and the speaker 34a are typically a color television receiver, and through the AV cable 32a, a video signal from the game apparatus 12 is input to a video input terminal of the color television, and a sound signal from the game apparatus 12 is input to a sound input terminal. Accordingly, a game image of a three-dimensional (3D) video game, for example, is displayed on the screen of the color television (monitor) 34, and stereo game sound, such as a game music, a sound effect, etc. is output from the right and left speakers 34a. Around the monitor 34 (on the top side of the monitor 34, in this embodiment), a marker unit 34b including two infrared ray LEDs (markers) 340m and 340n is provided. The marker unit 34b is connected to the game apparatus 12 through a power source cable 32b. Accordingly, the marker unit 34b is supplied with power from the game apparatus 12. Thus, the markers 340m and 340n emit lights ahead of the monitor 34.

Furthermore, the power of the game apparatus 12 is applied by means of a general AC adapter (not illustrated). The AC adapter is inserted into a standard wall socket for home use, and the game apparatus 12 transforms the house current (commercial power supply) to a low DC voltage signal suitable for driving. In another embodiment, a battery may be utilized as a power supply.

In the game system 10, a user or a player turns the power of the game apparatus 12 on for playing the game (or applications other than the game). Then, the user selects an appropriate optical disk 18 storing a program of a video game (or other applications the player wants to play), and loads the optical disk 18 into the disk drive 54 of the game apparatus 12. In response thereto, the game apparatus 12 starts to execute a video game or other applications on the basis of the program recorded in the optical disk 18. The user operates the first controller 22 in order to apply an input to the game apparatus 12. For example, by operating any one of the inputter 26, a game or other application is started. Besides the operation of the inputter 26, by moving the first controller 22 itself, it is possible to move a moving image object (player object) in different directions or change a perspective of the user (camera position) in a 3-dimensional game world.

Here, programs of the video game and other applications may be stored (installed) in an internal memory (flash memory 44 (see FIG. 2)) of the game apparatus 12 so as to be executed from the internal memory. In such a case, programs stored in a storage medium like an optical disk 18 may be installed onto the internal memory, or downloaded programs may be installed onto the internal memory.

FIG. 2 is a block diagram showing an electric configuration of the video game system 10 in FIG. 1 embodiment. Although illustration is omitted, the respective components within the housing 14 are mounted on a printed board. As shown in FIG. 2, the game apparatus 12 has a CPU 40. The CPU 40 functions as a game processor. The CPU 40 is connected with a system LSI 42. The system LSI 42 is connected with an external main memory 46, a ROM/RTC 48, a disk drive 54, and an AV IC 56.

The external main memory 46 is utilized as a work area or a buffer area of the CPU 40 for storing programs like a game program, etc., and various data. The ROM/RTC 48, the so-called boot ROM, is incorporated with a program for activating the game apparatus 12, and provided with a time circuit for counting a time. The disk drive 54 reads a program, image data, sound data, etc. from the optical disk 18, and writes them in an internal main memory 42e described later or the external main memory 46 under the control of the CPU 40.

The system LSI 42 is provided with an input-output processor 42a, a GPU (Graphics Processor Unit) 42b, a DSP (Digital Signal Processor) 42c, a VRAM 42d and an internal main memory 42e. These are connected with each other by internal buses although illustration is omitted. The input-output processor (I/O processor) 42a executes transmission and reception of data, downloads of data, and so forth. A description as to transmission and reception and download of the data follows later.

The GPU 42b is made up of a part of a depicter, and receives a graphics command (construction command) from the CPU 40 to generate game image data according to the command. Additionally, the CPU 40 applies an image generating program required for generating game image data to the GPU 42b in addition to the graphics command.

Although illustration is omitted, the CPU 42b is connected with the VRAM 42d as described above. The CPU 42b accesses the VRAM 42d to acquire the data (image data: data such as polygon data, texture data, etc.) required to execute the construction command. Additionally, the CPU 40 writes the image data required for drawing to the VRAM 42d via the GPU 42b. The GPU 42b accesses the VRAM 42d to create game image data for drawing.

In this embodiment, a description is made on a case that the GPU 42b generates game image data, but in a case of executing an arbitrary application except for the game application, the GPU 42b generates image data as to the arbitrary application.

Furthermore, the DSP 42c functions as an audio processor, and generates audio data corresponding to a sound, a voice, music, or the like by means of the sound data and the sound wave (tone) data which are stored in the internal main memory 42e and the external main memory 46.

The game image data and audio data which are generated as described above are read by the AV IC 56, and output to the monitor 34 and the speaker 34a via the AV connector 58. Accordingly, a game screen is displayed on the monitor 34, and a sound (music) necessary for the game is output from the speaker 34a.

Furthermore, the input-output processor 42a is connected with a flash memory 44, a wireless communication module 50, a wireless controller module 52, an expansion connector 60 and a connector for external memory card 62. The wireless communication module 50 is connected with an antenna 50a, and the wireless controller module 52 is connected with an antenna 52a.

Although illustration is omitted, the input-output processor 42a can communicate with other game apparatuses and various servers that are connected to a network via the wireless communication module 50. It should be noted that it is possible to directly communicate with other game apparatuses without going through the network. The input-output processor 42a periodically accesses the flash memory 44 to detect the presence or absence of data (referred to as transmission data) required to be transmitted to a network, and transmits it to the network via the wireless communication module 50 and the antenna 50a in a case that the transmission data is present. Furthermore, the input-output processor 42a receives data (referred to as reception data) transmitted from other game apparatuses via the network, the antenna 50a and the wireless communication module 50, and stores the reception data in the flash memory 44. if the reception data does not satisfy a predetermined condition, the reception data is abandoned as it is. In addition, the input-output processor 42a receives data (download data) downloaded from the download server via the network, the antenna 50a and the wireless communication module 50, and stores the download data in the flash memory 44.

Furthermore, the input-output processor 42a receives controller data transmitted from the first controller 22 via the antenna 52a and the wireless controller module 52, and (temporarily) stores it in the buffer area of the internal main memory 42e or the external main memory 46. The controller data is erased from the buffer area after being utilized in the processing by the CPU 40 (game processing, for example).

In this embodiment, as described above, the wireless controller module 52 performs a communication with the first controller 22 in accordance with Bluetooth standards. In FIG. 2, for simplicity, the gyro unit 24 and the second controller 36 are omitted.

In addition, the input-output processor 42a is connected with the expansion connector 60 and the connector for external memory card 62. The expansion connector 60 is a connector for interfaces, such as USB, SCSI, etc., and can be connected with medium such as an external storage, and peripheral devices such as other controllers different from the first controller 22 and the second controller 36. Furthermore, the expansion connector 60 is connected with a cable LAN adaptor, and the cable LAN can be used in place of the wireless communication module 50. The connector for external memory card 62 can be connected with an external storage like a memory card. Thus, for example, the input-output processor 42a accesses the external storage via the expansion connector 60 and the connector for external memory card 62 to store and read the data.

Although a detailed description is omitted, the game apparatus 12 (housing 14) is furnished with the power button 20a, the reset button 20b, and the eject button 20c as shown in FIG. 1. The power button 20a is connected to the system LSI 42. When the power button 20a is turned on, the system LSI 42 is set to a mode of a normal energized state in which the respective components of the game apparatus 12 are supplied with power through an AC adapter not shown (referred to as “normal mode”). On the other hand, when the power button 20a is turned off, the system LSI 42 is set to a mode in which only a part of the components of the game apparatus 12 is supplied with power, and the power consumption is reduced to minimum (hereinafter referred to as a “standby mode”).

In this embodiment, in a case that the standby mode is set, the system LSI 42 issues an instruction to stop supplying the power to the components except for the input-output processor 42a, the flash memory 44, the external main memory 46, the ROM/RTC 48, the wireless communication module 50, and the wireless controller module 52. Accordingly, in this embodiment, in the standby mode, the CPU 40 never performs the application.

Although the system LSI 42 is supplied with power even in the standby mode, generation of clocks to the GPU 42b, the DSP 42c and the VRAM 42d are stopped so as not to be driven, realizing reduction in power consumption.

Although illustration is omitted, inside the housing 14 of the game apparatus 12, a fan is provided for excluding heat of the IC, such as the CPU 40, the system LSI 42, etc. to outside. In the standby mode, the fan is also stopped.

However, in a case that utilizing the standby mode is not desired, by making the standby mode unusable, when the power button 20a is turned off, the power supply to all the circuit components are completely stopped.

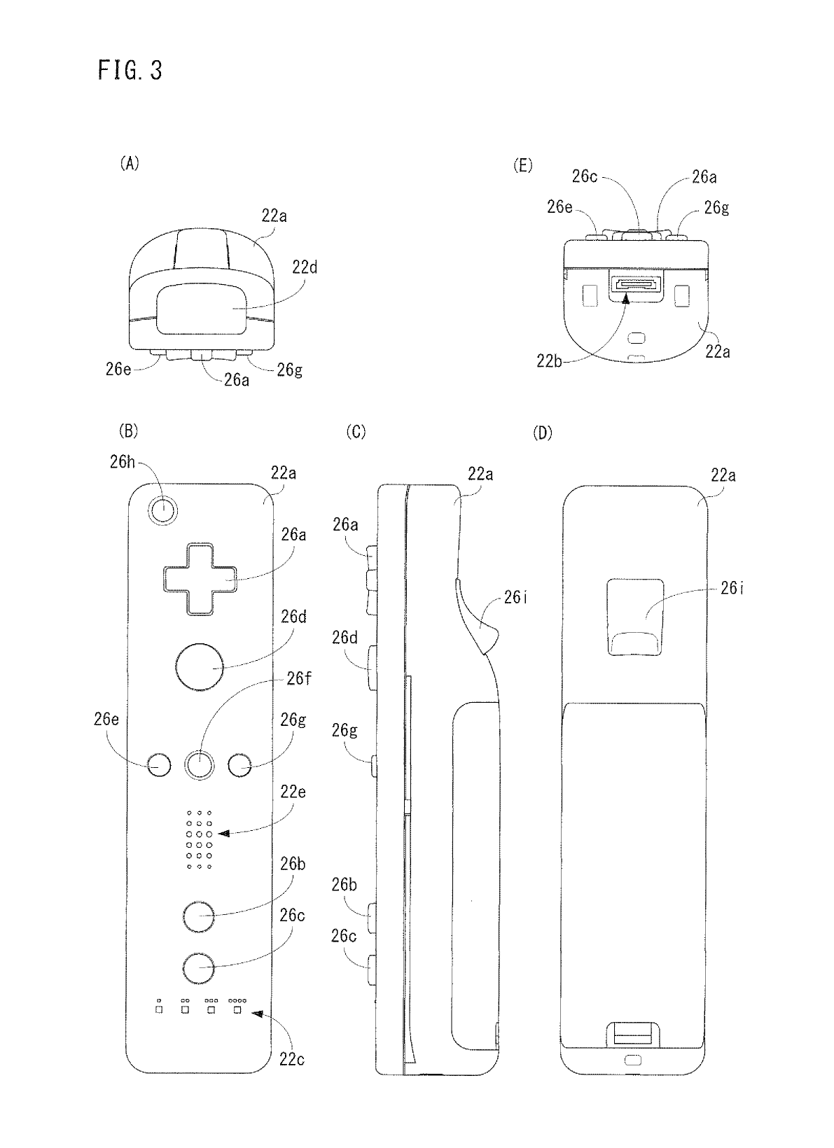

Furthermore, switching between the normal mode and the standby mode can be performed by turning on and off the power switch 26h (see FIG. 3(B)) of the first controller 22 by remote control. If the remote control is not performed, setting is made such that the power supply to the wireless controller module 52a is not performed in the standby mode.

The reset button 20b is also connected to the system LSI 42. When the reset button 20b is pushed, the system LSI 42 restarts the activation program of the game apparatus 12. The eject button 20c is connected to the disk drive 54. When the eject button 20c is pushed, the optical disk 18 is removed from the disk drive 54.

FIG. 3(A) to FIG. 3(E) show one example of an external appearance of the first controller 22. FIG. 3(A) shows a leading end surface of the first controller 22, FIG. 3(B) shows a top surface of the first controller 22, FIG. 3(C) shows a right surface of the first controller 22, FIG. 3(D) shows a bottom surface of the first controller 22, and FIG. 3(E) shows a trailing end of the first controller 22.

Referring to FIG. 3(A) to FIG. 3(E), the first controller 22 has a housing 22a formed by plastic molding, for example. The housing 22a is formed into an approximately rectangular parallelepiped shape and has a size small enough to be held by one hand of a user. The housing 22a (first controller 22) is provided with the inputter (a plurality of buttons or switches) 26. Specifically, as shown in FIG. 3(B), on a top surface of the housing 22a, there are provided a cross key 26a, a 1 button 26b, a 2 button 26c, an A button 26d, a −button 26e, a HOME button 26f, a +button 26g and a power switch 26h. Moreover, as shown in FIG. 3(C) and FIG. 3(D), an inclined surface is formed on a bottom surface of the housing 22a, and a B-trigger switch 26i is formed on the inclined surface.

The cross key 26a is a four directional push switch, including four directions of front (or upper), back (or lower), right and left operation parts. By operating any one of the operation parts, it is possible to instruct a moving direction of a character or an object (player character or player object) that is operable by a player, instruct the moving direction of a cursor, or merely instruct the direction.

The 1 button 26b and the 2 button 26c are respectively push button switches. They are used for a game operation, such as adjusting a viewpoint position and a viewpoint direction in displaying the 3D game image, i.e. a position and an image angle of a virtual camera. Alternatively, the 1 button 26b and the 2 button 26c can be used for the same operation as that of the A-button 26d and the B-trigger switch 26i or an auxiliary operation.

The A-button switch 26d is the push button switch, and is used for causing the player character or the player object to take an action other than a directional instruction, specifically arbitrary actions such as hitting (punching), throwing, grasping (acquiring), riding, and jumping, etc. For example, in an action game, it is possible to give an instruction to jump, punch, move a weapon, and so forth. Also, in a roll playing game (RPG) and a simulation RPG, it is possible to give an instruction to acquire an item, select and determine the weapon and command, and so forth. Furthermore, in a case that the first controller 22 is used as a pointing device, the A-button switch 26d is used to instruct a decision of an icon or a button image instructed by a pointer (instruction image) on the game screen. For example, when the icon or the button image is decided, an instruction or a command set in advance corresponding thereto can be input.

The −button 26e, the HOME button 26f, the +button 26g, and the power supply switch 26h are also push button switches. The −button 26e is used for selecting a game mode. The HOME button 26f is used for displaying a game menu (menu screen). The +button 26g is used for starting (resuming) or pausing the game. The power supply switch 26h is used for turning on/off a power supply of the game apparatus 12 by remote control.

In this embodiment, note that the power supply switch for turning on/off the first controller 22 itself is not provided, and the first controller 22 is set at on-state by operating any one of the switches or buttons of the inputter 26 of the first controller 22, and when not operated for a certain period of time (30 seconds, for example) or more, the first controller 22 is automatically set at off-state.

The B-trigger switch 26i is also the push button switch, and is mainly used for inputting a trigger such as shooting, and designating a position selected by the first controller 22. In a case that the B-trigger switch 26i is continued to be pushed, it is possible to make movements and parameters of the player object constant. In a fixed case, the B-trigger switch 26i functions in the same way as a normal B-button, and is used for canceling the action and the command determined by the A-button 26d.

As shown in FIG. 3(E), a connector 22b is provided on a trailing end surface of the housing 22a, and as shown in FIG. 3(B), an indicator 22c is provided on the top surface and on the side of the trailing end surface of the housing 22a. In this embodiment, the connector 22b is provided for mainly connecting the gyro unit 24. The indicator 22c is made up of four LEDs, for example. The indicator 22c can show identification information (controller number) of the first controller 22 by lighting any one of the four LEDs and according to the lighted LED, and show the remaining amount of the battery of the first controller 22 depending on the number of LEDs to be emitted.

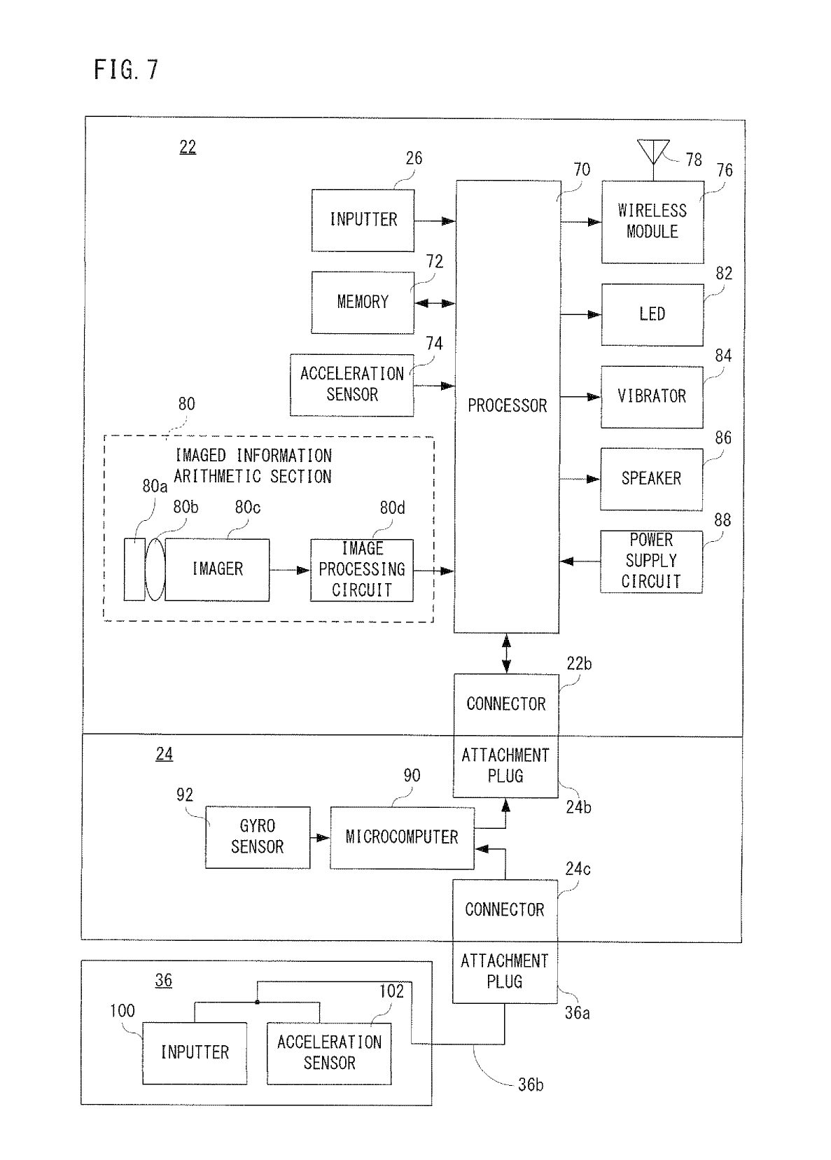

In addition, the first controller 22 has an imaged information arithmetic section 80 (see FIG. 7), and a light incident opening 22d of the imaged information arithmetic section 80 is provided on the leading end surface of the housing 22a as shown in FIG. 3(A). Furthermore, the first controller 22 has a speaker 86 (see FIG. 7), and the speaker 86 is provided inside the housing 22a at the position corresponding to a sound release hole 22e between the 1 button 26h and the HOME button 26f on the top surface of the housing 22a as shown in FIG. 3(B).

Note that the shape of the first controller 22 and the shape, number and setting position of each inputter 26 shown in FIG. 3(A) to FIG. 3(E) are simply one example, and needless to say, even if they are suitably modified, the present embodiment can be implemented.

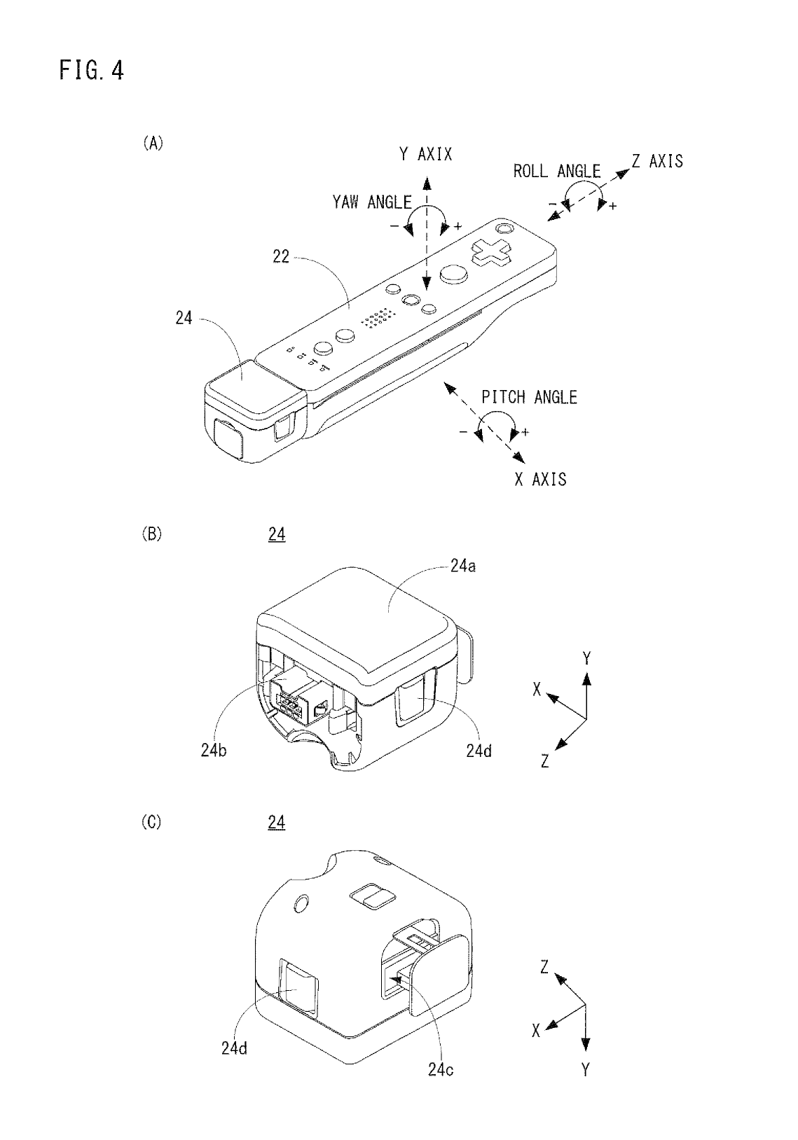

FIG. 4(A) shows an example non-limiting a state that the gyro unit 24 is connected to the first controller 22 as shown in FIG. 1. The gyro unit 24 is connected to the trailing end surface of the first controller 22 (on the side of the indicator 22c). As shown in FIG. 4(B), the gyro unit 24 has a housing 24a formed by plastics molding similar to the first controller 22. The housing 24a is a substantially cubic shape, and has an attachment plug 24b to be connected to the connector 22b of the first controller 22 on the side for connection to the first controller 22. Furthermore, as shown in FIG. 4(C), on the opposite side to the side where the attachment plug 24b is provided, a connector 24c is provided. Although detailed description is omitted, when the gyro unit 24 is connected to the first controller 22, a rock mechanism maintains the connected state. The connected state is cancelled when the cancel buttons 24d provided both of the side surfaces of the gyro unit 24 are pushed. This makes it possible to detachably attach the gyro unit 24 to the first controller 22.

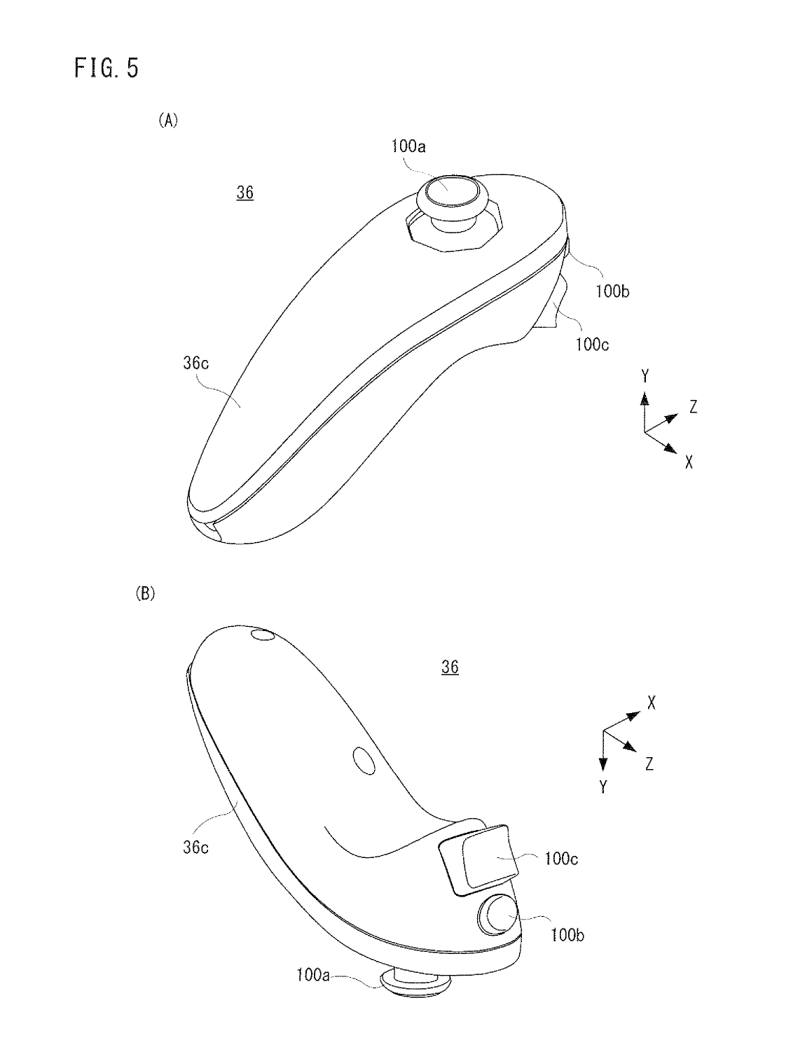

FIG. 5 shows an example non-limiting appearance of the second controller 36. FIG. 5(A) is a perspective view of the second controller 36 as seeing it from above rear, and FIG. 5(B) is a perspective view of the second controller 36 as seeing it from below front. It should be noted that in FIG. 5, the attachment plug 36a and the cable 36b of the second controller 36 are omitted. The second controller 36 has a housing 36c formed by plastic molding, for example. As shown in FIG. 5(A) and (B), The housing 36c is formed into an approximately thin long elliptical shape in the forward and backward directions (Z-axis direction) when viewed from plane, and has the width of the right and left direction (X-axis direction) at the rear end narrower than that of the front end. Furthermore, the housing 36c has a curved shape as a whole when viewed from a side, and downwardly curved from a horizontal portion at the front end to the rear end. The housing 36c has a size small enough to be held by one hand similar to the first controller 22, and has a longitudinal length (in the Z-axis direction) slightly shorter than that of the housing 22a of the first controller 22. As with the case of the second controller 36, the player can perform a game operation by operating buttons and a stick, and by changing a position and a direction of the controller itself.

At a front end of the top surface of the housing 36e, an analog joystick 100a is provided. At an end of the housing 36c, a front surface slightly inclined backward is provided, and on the front surface are provided a C button 100b and a Z button 100c vertically (Y-axis direction in FIG. 5) arranged. The analog joystick 100a and the respective buttons 100b and 100c are assigned appropriate functions according to a game program to be executed by the game apparatus 12. The analog joystick 100a and the respective buttons 100b and 100c provided to the second controller 36 may inclusively be denoted as an inputter 100.

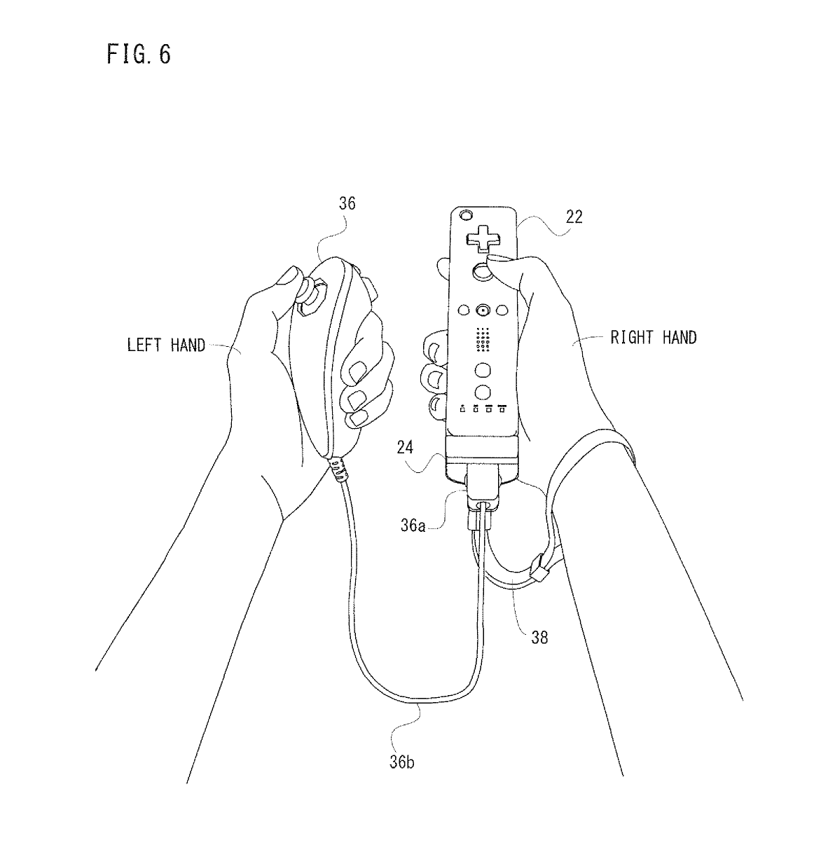

In this game system 10, a user can make an input with respect to an application like a game, or the like by moving the first controller 22 itself and the second controller 36 other than a button operation. In playing the game, for example, the player holds the first controller 22 with the right hand and the second controller 36 with the left hand as shown in FIG. 6. Although it is difficult to understand in the drawing, at the rear surface of the first controller 22, a strap 38 is attached so as to be hung on the wrist of the right hand of the player. This makes it possible to prevent the first controller 22 from being released during playing the game.

As described above, the first controller 22 contains an acceleration sensor 74 for detecting accelerations in the three-axis directions, and the second controller 36 contains a similar acceleration sensor 102. When the first controller 22 and the second controller 36 are moved by the player, acceleration values in the three-axis directions (see FIG. 4, FIG. 5) indicating the motions of the controllers themself are detected by the acceleration sensor 74 and the acceleration sensor 102. Furthermore, in this embodiment, the first controller 22 is attached with the gyro unit 24, and therefore, the angular velocity values (see FIG. 4) about the three axes indicating the motions of the first controller 22 itself are further detected.

The data corresponding to the detected values is transmitted to the game apparatus 12 being included in the aforementioned controller data. In the game apparatus 12, the controller data from the controller 14 is received by the input-output processor 64a via the antenna 52a and the wireless controller module 52, and the received controller data is written to a buffer area of the internal main memory 42e or the external main memory 46 by the input-output processor 42a. The CPU 40 reads the controller data stored in the buffer area of the internal main memory 42e or the external main memory 46, and restores the detected value, that is, the values of the acceleration and/or the angular velocity detected by the controller 14 from the controller data.

The CPU 44 may execute processing for calculating a velocity of the first controller 22 and the second controller 36 from the restored acceleration in parallel with such a restoring processing. In parallel therewith, a travel distance or a position of the first controller 22 and the second controller 36 can be evaluated from the calculated velocity. On the other hand, from the restored angular velocity, a rotation angle of the first controller 22 is evaluated.

Here, an initial value (constant of integration) when the accelerations are accumulated to calculate the velocity, and the angular velocities are accumulated to calculate the rotation angle can be calculated from the position coordinate data from the imaged information arithmetic section 80 as described above, for example. The position coordinate data can also be used for correcting the errors accumulated due to the integration.

The game processing is executed on the basis of the variables thus evaluated, such as the acceleration, the velocity, the travel distance, the angular velocity, the rotation angle, etc. Accordingly, all of the processing described above need not to be executed, and the variables necessary for the game processing may be calculated as required. It should be noted that the angular velocity and the rotation angle can also be calculated from the acceleration in principle, but this requires a complex routine for the game program, which also imposes a heavy processing load on the CPU 44. By utilizing the gyro sensor unit 24, a development of the program is made easy, and the processing load on the CPU 40 is reduced.

FIG. 7 show an example non-limiting electric configuration of the first controller 22, the gyro unit 24 and the second controller 36. Referring to FIG. 7, the first controller 22 includes a processor 70, and the processor 70 is connected with the connector 22b, the inputter 26, a memory 72, the acceleration sensor 74, a wireless module 76, the imaged information arithmetic section 80, an LED 82 (indicator 22c), a vibrator 84, the speaker 86 and a power supply circuit 88 by an internal bus (not shown). Also, the wireless module 76 is connected with an antenna 78.

Although omitted in FIG. 7 for the sake of simplicity, the indicator 22c is made up of four LEDs 82 as described above.

The processor 70 first entirely controls the first controller 22, and transmits (inputs) the information (input information) input by the inputter 26, the acceleration sensor 74 and the imaged information arithmetic section 80 as controller data to the game apparatus 12 via the wireless module 76 and the antenna 78. At this time, the processor 70 utilizes the memory 72 as a working area or a buffer area. Furthermore, the operation signal (operation data) from the above-described inputter 26 (26a-26i) is input to the processor 70, and the processor 70 temporarily stores the operation data in the memory 72.

Moreover, as shown in FIG. 4, the acceleration sensor 74 detects each acceleration of the controller 22 in directions of three axes of vertical direction (Y-axial direction), lateral direction (X-axial direction), and forward and rearward directions (Z-axial direction). The acceleration sensor 74 is typically an acceleration sensor of an electrostatic capacity type, but the acceleration sensor of other types may also be used. For example, the acceleration sensor 74 detects accelerations (ax, ay, and az) in each direction of X-axis, Y-axis, Z-axis, and inputs the data of the acceleration (acceleration data) thus detected to the processor 70. For example, the acceleration sensor 74 detects the acceleration in each direction of the axes in a range from −2.0 g to 2.0 g (g indicates a gravitational acceleration. This holds true below.) The processor 70 detects the acceleration data given from the acceleration sensor 74, and temporarily stores it in the memory 72. Accordingly, proper arithmetic process is performed on the detected accelerations to thereby calculate a tilt and a rotation of the first controller 22 and an attitude of the acceleration sensor 74 in the direction of gravity. Also, motions applied to the first controller 22 by swings, etc. can similarly be calculated.

The processor 70 creates controller data including at least operation data from the first controller 22, acceleration data from the first controller 22, marker coordinate data described later, angular velocity data described later, operation data of the second controller described later and acceleration data of the second controller described later, and transmits the created controller data to the game apparatus 12.

Although omitted in FIG. 3(A) to FIG. 3(E), the acceleration sensor 74 is provided inside the housing 22a on the circuit board in the vicinity of a place where the cross key 26a is arranged in this embodiment.

The wireless module 76 modulates a carrier of a predetermined frequency by the controller data by using a technique of Bluetooth, for example, and emits its weak radio wave signal from the antenna 78. Namely, the controller data is modulated to the weak radio wave signal by the wireless module 76 and transmitted from the antenna 78 (first controller 22). The weak radio wave signal thus transmitted is received by the wireless controller module 52 provided to the aforementioned game apparatus 12. The weak radio wave thus received is subjected to demodulating and decoding processing. This makes it possible for the game apparatus 12 (CPU 40) to acquire the controller data from the first controller 22. Then, the CPU 40 performs the processing of the application (game processing), following the acquired controller data and the application program (game program).

In addition, as described above, the first controller 22 is provided with the imaged information arithmetic section 80. The imaged information arithmetic section 80 is made up of an infrared rays filter 80a, a lens 80b, an imager 80c, and an image processing circuit 80d. The infrared rays filter 80a passes only infrared rays from the light incident from the front of the first controller 22. As described above, the markers 340m and 340n placed near (around) the display screen of the monitor 34 are infrared. LEDs for outputting infrared lights ahead of the monitor 34. Accordingly, by providing the infrared rays filter 80a, it is possible to image the image of the markers 340m and 340n more accurately. The lens 80b condenses the infrared rays passing thorough the infrared rays filter 80a to emit them to the imager 80c. The imager 80c is a solid imager, such as a CMOS sensor and a CCD, for example, and images the infrared rays condensed by the lens 80b. Accordingly, the imager 80c images only the infrared rays passing through the infrared rays filter 80a to generate image data. Hereafter, the image imaged by the imager 80e is called an “imaged image”. The image data generated by the imager 80c is processed by the image processing circuit 80d. The image processing circuit 80d calculates a position of an object to be imaged (markers 340m and 340n) within the imaged image, and outputs each coordinate value indicative of the position to the processor 70 as imaged data (marker coordinate data described later). It should be noted that the processing in the image processing circuit 80d is described later.

Furthermore, the first controller 22 is connected with the gyro unit 24. As understood from FIG. 5, the attachment plug 24b is connected to the connector 22b. The attachment plug 24b is connected with a microcomputer 90 with a signal line. The microcomputer 90 is connected with a gyro sensor 92, and connected with the connector 24c with a signal line.

The gyro sensor 92, as shown in FIG. 4, detects angular velocities about three axes of vertical direction (about a Y-axial direction), lateral direction (about a X-axial direction), and forward and rearward directions (about an Z-axial direction) of the controller 22. Here, a rotation about the Y axis is represented by a yaw angle, a rotation about the X axis is represented by a pitch angle, and a rotation about the Z axis is represented by a roll angle. The gyro sensor 92 can employ a typically piezoelectric vibration type, but may employ other types.

For example, the gyro sensor 92 detects an angular velocity (ωx, ωy, ωz) in relation to each of the X axis, the Y axis, and the Z axis, and inputs the detected angular velocities to the microcomputer 90. Here, when the angular velocities are converted from analog signals to digital data when input to the microcomputer 90. The gyro sensor 92 used in this embodiment can measure an angular velocity relative to each axis in the range from 0 to 1500 dps (degree percent second). In the virtual game of this embodiment described later, the range from 900 to 1500 dps is a range of measure relative to the yaw angle, and the range from 0 to 1500 dps is a range of measure relative to the pitch angle and the roll angle.

Here, the sensor is a gyro sensor (angular velocity sensor) in this embodiment, but may be other motion sensors, such as an acceleration sensor, a velocity sensor, a displacement sensor, a rotation angle sensor, etc. The sensor includes a slant sensor, an image sensor, an optical sensor, a pressure sensor, a magnetic sensor, a temperature sensor, etc. other than the motion sensors, and in a case that either sensor is added, an operation by utilizing an object to be detected of the sensor is made possible. In a case that either sensor is utilized, the sensor can be added to the operating device while another device connected to the conventional operating device is utilized as it is.

The microcomputer 90 detects an angular velocity applied from the gyro sensor 92, and temporarily stores the detected angular velocity data corresponding to the angular velocity in a memory (not illustrated) included in the microcomputer 90. Then, the microcomputer 90 transmits the angular velocity data temporarily stored in the memory to the first controller 22 (processor 70). Thus, the controller data may include the angular velocity data.

Noted that in this embodiment, the microcomputer 90 temporarily stores the angular velocity data in the memory, and transmits the same in batches to a certain degree to the processor 70, but may directly transmit the angular velocity data to the processor 70 without temporarily storing the same in the memory.

Inside the housing 36c of the second controller 36, the acceleration sensor 102 (FIG. 7) is provided. As the acceleration sensor 102, an acceleration sensor similar to the acceleration sensor 74 of the first controller 22 is applied. More specifically, a three-axis acceleration sensor is applied in this embodiment, and detects accelerations in each of the three axis directions such as an up and down direction (Y-axial direction shown), a right and left direction (X-axial direction shown), and a forward and backward direction (Z-axial direction shown) of the second controller 36. Accordingly, similar to the case of the first controller 22, proper arithmetic processing is performed on the detected accelerations to thereby calculate a tilt and a rotation of the second controller 36 and an attitude of the acceleration sensor 102 in the direction of gravity. Furthermore, it is possible to calculate a motion applied to the second controller 36 by swinging, etc.

In addition, the power source is applied by a battery (not illustrated) which is replaceably accommodated in the first controller 22. The gyro unit 24 is supplied with the power via the connector 22b and the attachment plug 24b. Moreover, a part of the power supplied from the first controller 22 to the gyro unit 24 is applied to the second controller 36 via the connector 24c, the attachment plug 36a and the cable 36b.

As described above, when a game is played in the video game system 10 by utilizing the first controller 22 and the second controller 36, the player holds the first controller 22 with one hand (right hand) and holds the second controller 36 with the other hand (left hand). Here, the gyro unit 24 is attached to the first controller 22. In a case that the first controller 22 is used as a pointing device, the player holds the controller 22 in a state that the front end surface (the side of the incident light opening 22d of the light imaged by the imaged information arithmetic section 80) of the controller 22 is oriented to the markers 340m and 340n. It should be noted that as can be understood from FIG. 1, the markers 340m and 340n are placed in parallel with the horizontal direction of the screen of the monitor 34. In this state, the player performs a game operation by changing a position on the screen designated by the first controller 22, and changing a distance between the first controller 22 and each of the markers 340m and 340n.

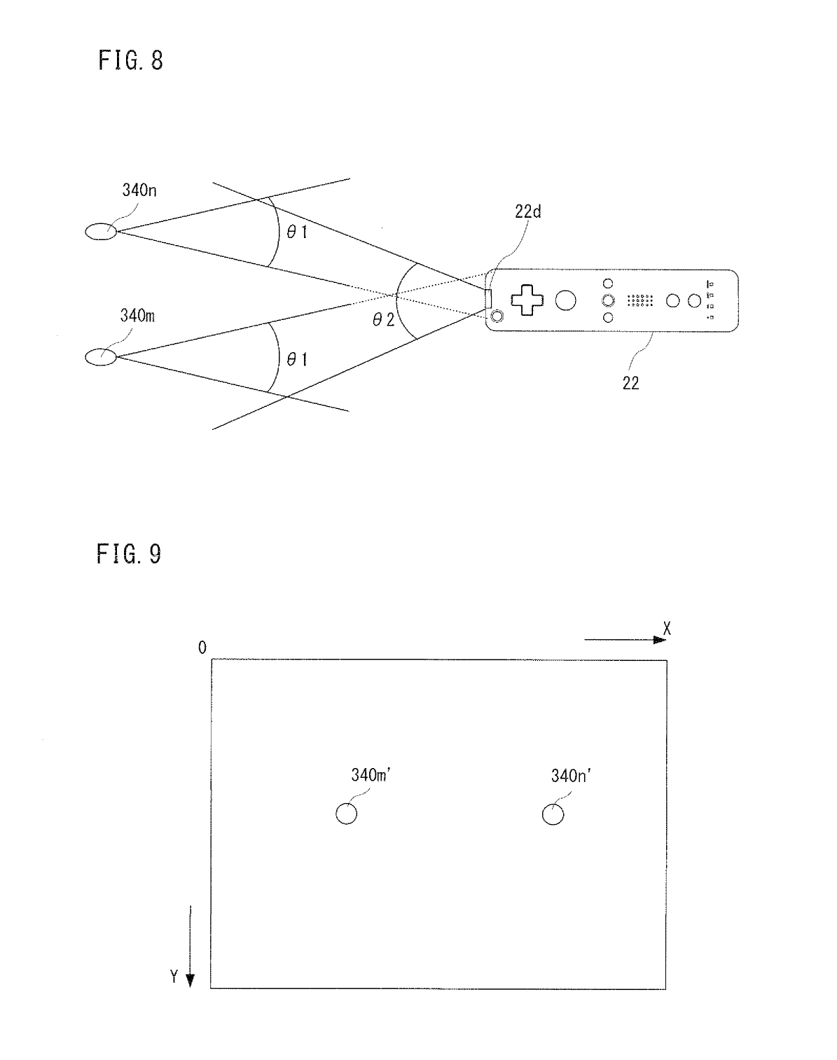

FIG. 8 is a view showing viewing angles between the respective markers 340m and 340n, and the first controller 22. For the sake of simplicity, in FIG. 8, the gyro unit 24 and the second controller 36 are omitted. As shown in FIG. 8, each of the markers 340m and 340n emits infrared ray within a range of a viewing angle θ1. Also, the imager 80c of the imaged information arithmetic section 80 can receive incident light within the range of the viewing angle θ2 with the line of sight of the first controller 22 as center. For example, the viewing angle θ1 of each of the markers 340m and 340n is 34° (half-value angle) while the viewing angle θ2 of the imager 80c is 41°. The player holds the first controller 22 such that the imager 80c is directed and positioned so as to receive the infrared rays from the markers 340m and 340n. More specifically, the player holds the first controller 22 such that at least one of the markers 340m and 340n exists in the viewing angle θ2 of the imager 80c, and the first controller 22 exists in at least one of the viewing angles θ1 of the marker 340m or 340n. In this state, the first controller 22 can detect at least one of the markers 340m and 340n. The player can perform a game operation by changing the position and the attitude of the first controller 22 in the range satisfying the state.

If the position and the attitude of the first controller 22 are out of the range, the game operation based on the position and the attitude of the first controller 22 is performed on the basis of the angular velocity detected by the gyro unit 24. Hereafter, the above-described range is called a “pointing operation allowable range”.

If the controller 22 is held within the pointing operation allowable range, an image of each of the markers 340m and 340n is imaged by the imaged information arithmetic section 80. That is, the imaged image obtained by the imager 80c includes an image (object image) of each of the markers 340m and 340n as an object to be imaged. FIG. 9 is an illustrative view showing one example of the imaged image including the object images. The image processing circuit 80d calculates coordinates (marker coordinates) indicative of the position of each of the markers 340m and 340n in the imaged image by utilizing the image data of the imaged image including the object images.

Since the object image appears as a high-intensity part in the image data of the imaged image, the image processing circuit 80d first detects the high-intensity part as a candidate of the object image. Next, the image processing circuit 80d determines whether or not the high-intensity part is the object image on the basis of the size of the detected high-intensity part. The imaged image may include images other than the object image due to sunlight through a window and light of a fluorescent lamp in the room as well as the images 340m′ and 340n′ corresponding to the two markers 340m and 340n as an object image. The determination processing whether or not the high-intensity part is an object image is executed for discriminating the images 340m′ and 340n′ as an object image from the images other than them, and accurately detecting the object image. More specifically, in the determination processing, it is determined whether or not the detected high-intensity part is within the size of the preset predetermined range. Then, if the high-intensity part is within the size of the predetermined range, it is determined that the high-intensity part represents the object image. On the contrary, if the high-intensity part is not within the size of the predetermined range, it is determined that the high-intensity part represents the images other than the object image.

In addition, as to the high-intensity part which is determined to represent the object image as a result of the above-described determination processing, the image processing circuit 80d calculates the position of the high-intensity part. More specifically, the barycenter position of the high-intensity part is calculated. Here, the coordinates of the barycenter position is called a “marker coordinate”. Also, the barycenter position can be calculated with more detailed scale than the resolution of the imager 80c. Now, the resolution of the imaged image imaged by the imager 80c shall be 126×96, and the barycenter position shall be calculated with the scale of 1024×768. That is, the marker coordinate is represented by the integer from (0, 0) to (1024, 768).

Additionally, the position in the imaged image shall be represented by a coordinate system (XY coordinate system) taking the upper left of the imaged image as an origin point, the downward direction as an Y-axis positive direction, and the right direction as an X-axis positive direction.

Also, if the object image is properly detected, two high-intensity parts are determined as object images by the determination processing, and therefore, two marker coordinates are calculated. The image processing circuit 80d outputs data indicative of the calculated two marker coordinates. The data of the output marker coordinates (marker coordinate data) is included in the controller data by the processor 70 as described above, and transmitted to the game apparatus 12.

The game apparatus 12 (CPU 40) detects the marker coordinate data from the received controller data to thereby calculate an designated position (designated coordinate) by the first controller 22 on the screen of the monitor 34 and a distances from the first controller 22 to each of the markers 340m and 340n on the basis of the marker coordinate data. More specifically, from the position of the mid point of the two marker coordinates, a position to which the first controller 22 faces, that is, a designated position is calculated. The distance between the object images in the imaged image is changed depending on the distance between the first controller 22 and each of the markers 340m and 340n, and therefore, the game apparatus 12 can grasp the distance between the first controller 22 and each of the markers 340m and 340n by calculating the distance between the two marker coordinates.

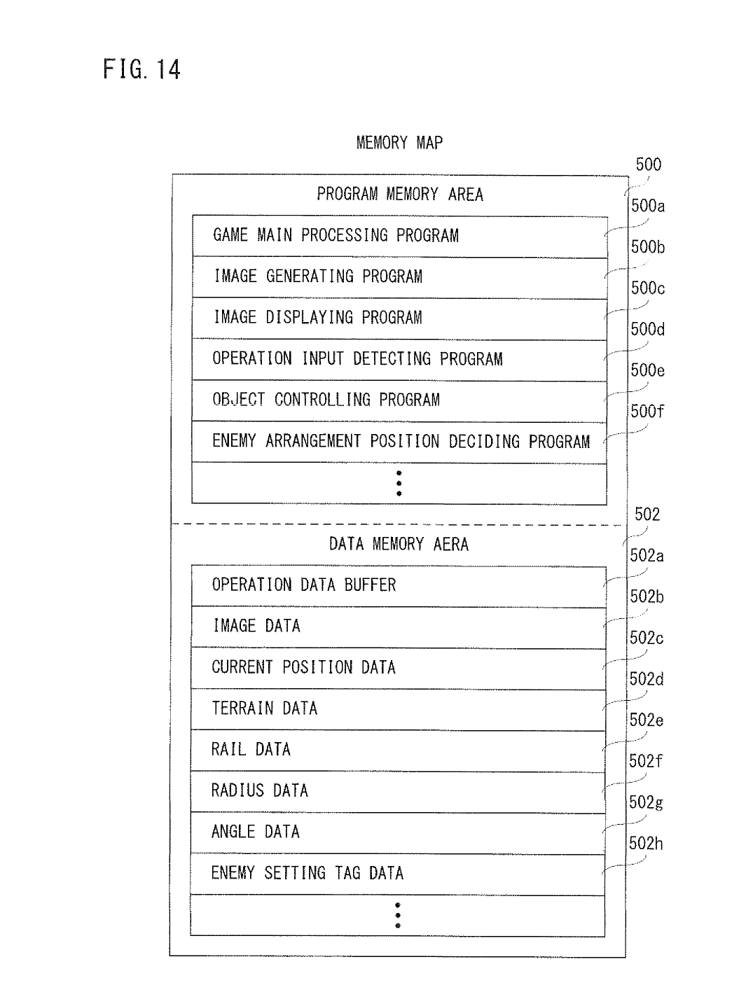

It should be noted that each output to the above-described processor 70 is executed every 1/200 sec., for example. Accordingly, the operation data from the inputter 26, the position coordinate data from the imaged information arithmetic section 80, the acceleration data from the acceleration sensor 74, the angular velocity data from the gyro sensor 92, the operation data from the inputter 100, and the acceleration data from the acceleration sensor 102 are once output to the processor 70 for arbitrary 1/200 sec. Furthermore, the controller data is transmitted to the game apparatus 12 every 1/200 sec., for example. The wireless controller module 52 receives the controller data transmitted from the controller 22 at predetermined cycles (1/200 sec. for example), and stores them in a buffer not shown included in the wireless controller module 52. Thereafter, the game apparatus 12 reads the controller data stored during the period by the input processor 42a every frame (screen updating rate: 1/60 sec.), and stores it in the operation data buffer 502a (see FIG. 14) under the control of the CPU 40. The CPU 40 executes game processing according to the controller data with reference to the operation data buffer 502a.

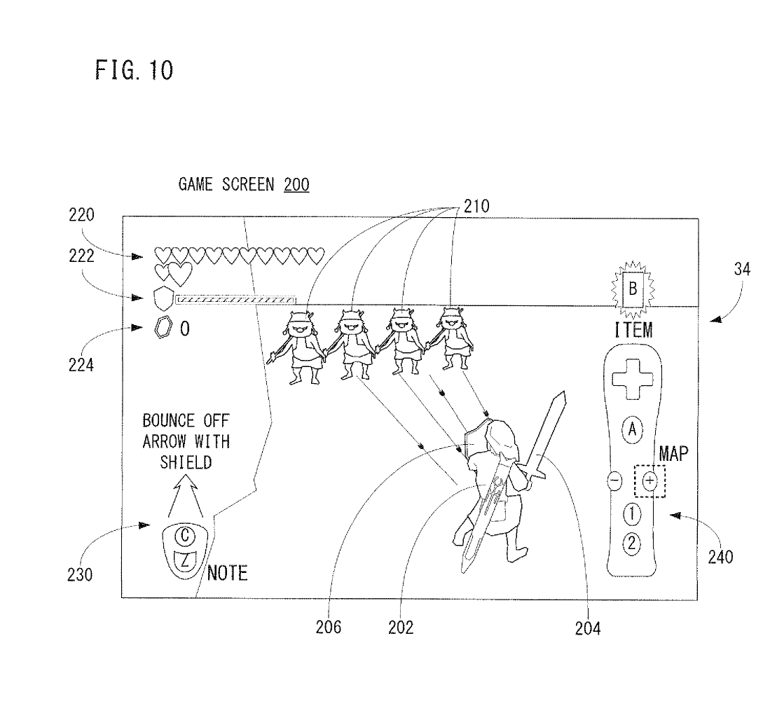

In the game system 10 as described above, it is possible to play a virtual game. FIG. 10 shows one example of a game screen 200 to be displayed on the monitor 34 in the virtual game of this embodiment. Although detailed description is omitted, a background object, such as a ground object, a building object and a terrain object is provided, and a player object 202 is arranged within the virtual game space. Furthermore, an item object (hereinafter, simply referred to as “item”) and enemy objects 210, etc. are arranged in the virtual game space as necessary. An image imaging this virtual game space with a virtual camera (not illustrated) is displayed on the monitor 34 as a game screen. This holds true for a case that the screen is displayed.

As shown in FIG. 10, on the game screen 200, the player object 202 is displayed toward the bottom right of the screen from the center thereof. The player object 202 of this embodiment has a sword object 204 with the right hand and a shield object 206 with the left hand. Furthermore, on the game screen 200, a plurality of enemy objects 210 (4 objects, here) are horizontally aligned toward the top of the screen from the center thereof. On the game screen 200, a state in which the enemy object 210 releases an arrow object, and the player object 202 protects from it with the shield object 206 is displayed.

Although it is difficult to understand in the drawings, a place where the player object 202 and the enemy objects 210 exist are displayed as a background.

In addition, at the upper left of the game screen 200, an image (heart image) 220 representing the life of the player object 202, an image 222 representing a defensive power of the shield object 206 and an image 224 indicating the number of possessing predetermined items are displayed. Furthermore, at the bottom left of the game screen 200, an image 230 indicating an operation method of the second controller 36 is displayed. Then, at the right end of the game screen 200, an image 240 indicating the operation method of the first controller 22 is displayed.

Simply speaking, when the +button 26g of the first controller 22 is operated, a map (game map) is displayed on the monitor 34. Furthermore, when the B trigger switch 26i of the first controller 22 is operated, an item selecting and using screen is displayed on the monitor 34.

Additionally, although not displayed on the game screen 200, the first controller 22 connected with the gyro unit 24 corresponds to the sword object 204 that the player object 202 holds, and when the first controller 22 is swung, the sword object 204 also moves in accordance with the movement. This makes it possible to cut the enemy object 210 and other objects (not illustrated). Although detailed description is omitted, it is also possible to make an action other than cutting the enemy object 210 and other objects by using the sword object 204.

Here, a movement of the sword object 204 in operatively associated with first controller 22 connected with the gyro unit 24 is not an essential content of the present application, and thus, the detailed description is omitted. For example, it is possible to use the art disclosed in the Japanese Patent Application Laying-Open No. 2010-142561 which is filed earlier by the applicant of the present application and has already been laid-opened.

In addition, with respect to the second controller 36, the C button 100b is operated to thereby make the player object 202 perform an action of bouncing off with the shield object 206. Accordingly, it is possible to bounce off the arrow released by the enemy object 210 with the shield object 206. Also, the Z button 100c is operated to thereby make the player object 202 note the enemy object 210. For example, if the player object 202 is caused to note the enemy object 210, the player object 202 does not lose sight of the enemy object 210 during the fighting.

Here, although not displayed on the game screen 200, by swing the second controller 36 as well, it is possible to cut the enemy object 210 and other objects. Although detailed description is omitted, how to cut (cut technique) is different between a ease that the first controller 22 is swung and a case that the second controller 36 is swung.

In this virtual game, in accordance with an operation by the player, the player object 202 is caused to move and make a predetermined action, such as a swinging action of the sword object 204 and a defending action with the shield object 206. This allows the player object 202 to fight with the enemy object 210, defeat the enemy object 210, acquire an item, and go to a predetermined place to thereby clear the stages prepared in advance, and when the final purpose is attained, the game is cleared. However, when the player object 202 is defeated by the enemy object 210, the game is over.

Generally, in such a virtual game, a position where the enemy object 210 is arranged (made to appear) is decided in advance, or decided at random within a range where the enemy object 210 is to be arranged (is made to appear). In the former case, the place where the enemy object 210 will appear in the same scene is clear, making the virtual game monotonous. Also, in the latter case, it is possible to avoid the virtual game from becoming monotonous, but the enemy object 210 may appear in a place too far from or too close to the player object 202, resulting in an inappropriate place where the enemy object 210 is made to appear. That is, there is a problem that arranging objects (non-player object) such as the enemy object 210 at an appropriate position depending on situations, such as the surrounding environment, is difficult.

Thereupon, in this embodiment, the arrangement position of the object is decided in correspondence with parameters defined in the terrain and a current position of the player object 202 to thereby appropriately arrange the object in correspondence with the situations. Hereinafter, a case of arranging the enemy object 210 is explained in detail.

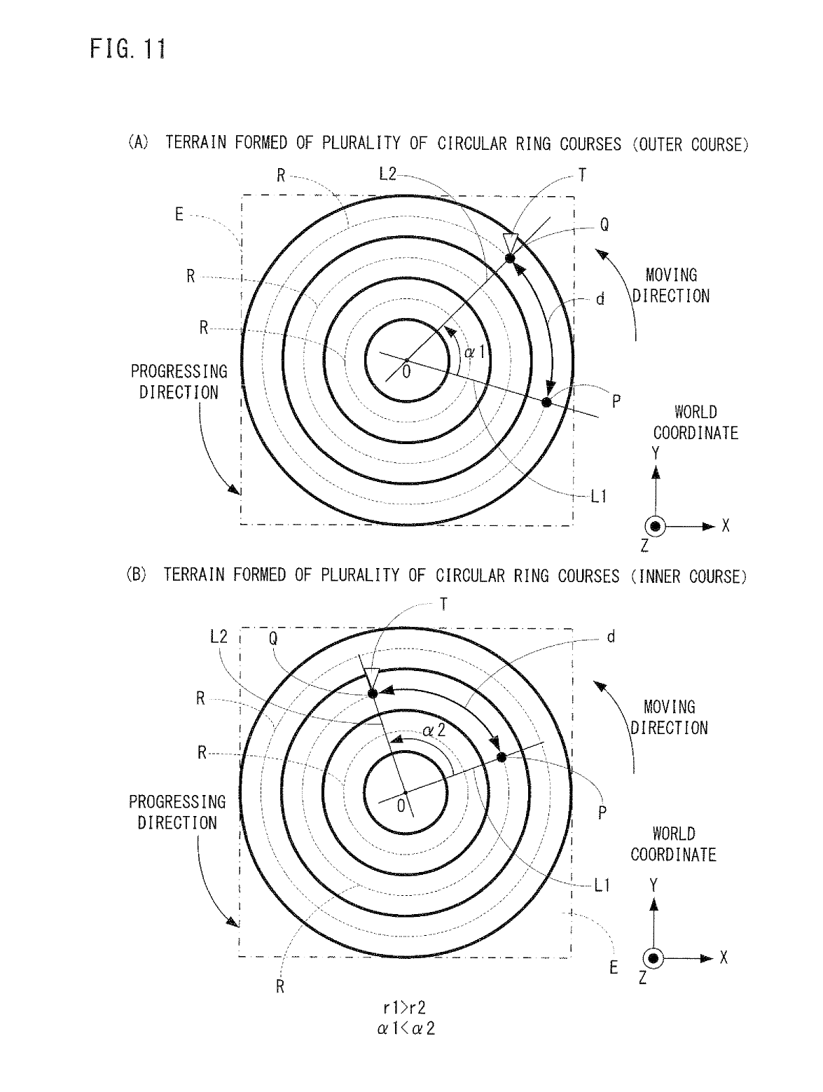

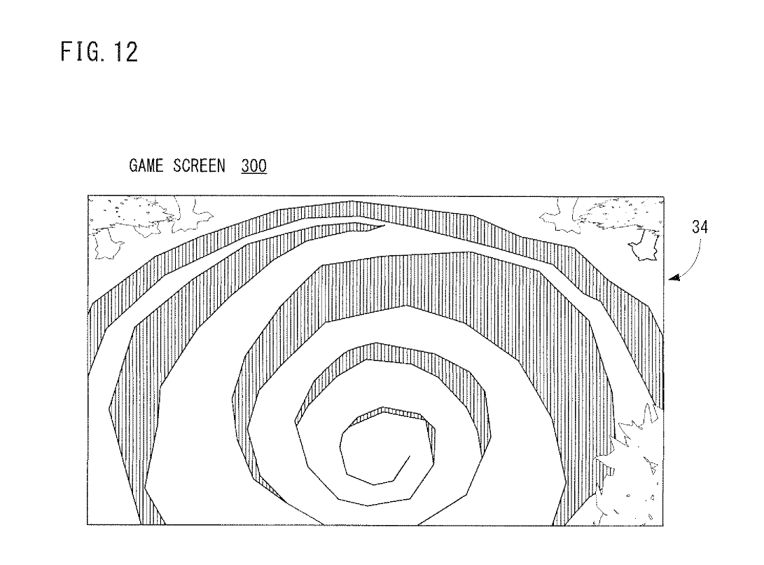

FIG. 11(A) and FIG. 11(B) show a terrain formed of a plurality of circular curved courses (ring courses) provided within the virtual game space. Here, the respective rings are different in diameter. Furthermore, the respective courses shall be the same or approximately the same in height. In each course, the player object 202 moves in a predetermined progressing direction (counterclockwise here), for example, and fights with the appearing enemy object 210. Here, the “progressing direction” means a direction (route) in which the player object 202 should progress on the course. Also, hereafter, a direction in which the player object 202 actually moves or to which the player object 202 turns (direction of the visual range) shall be a “moving direction”.

Here, in FIG. 11(A) and FIG. 11(B), the progressing direction and the moving direction are coincident with each other.

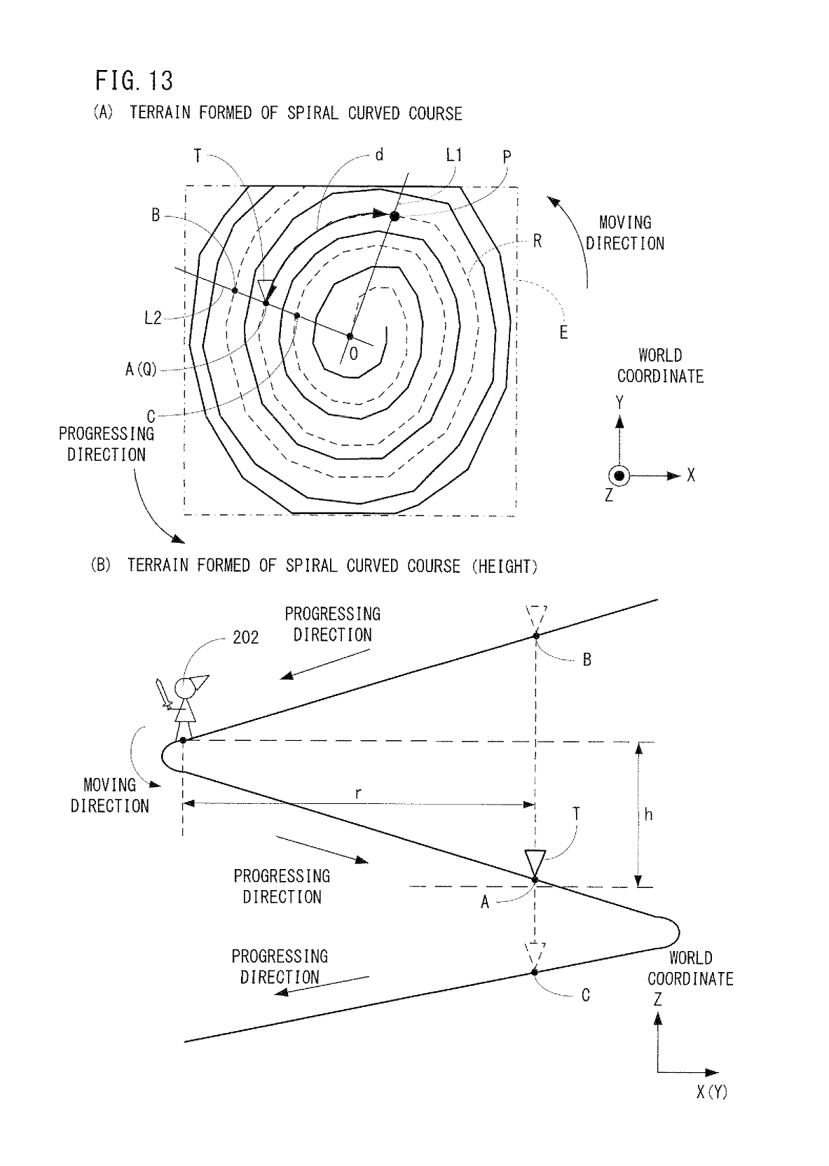

Although detailed description is omitted, in the virtual game space, as shown in FIG. 11 (A) and FIG. 11(B), a lateral direction is an X-axis direction, a longitudinal direction is a Y-axis direction, and a direction vertical to the X axis and the Y axis is a Z-axis direction. Furthermore, for example, the right direction is a plus direction of the X axis, the upward direction is a plus direction of the Y axis, and a direction vertical to the paper and going upward is a plus direction of the Z axis. This holds true in FIG. 13(A) described later.

For example, in the terrain shown in FIG. 11(A) and FIG. 11(B), the player object 202 progresses from the outermost course to inner courses in turn. When the player object 202 defeats all or a predetermined number or more enemy objects 210 which are arranged (are made to appear) on each course, it can progress to the next course. After the player object 202 defeats all or a predetermined number or more enemy objects 210 on the innermost course, it can fight with the enemy object 210 being a boss. Then, when the player object 202 defeats the boss enemy object 210, a predetermined item is acquired or another course appears.

Here, when the player object 202 reaches the innermost course, it can be set to fight with the boss enemy object 210. Also, a predetermined item may be acquired or another course may appear without fighting with the boss enemy object 210. These are matters to be arbitrarily set by game programmers or developers.

It should be noted that the player object 202 is set to progress from the outermost course to the inner courses in order, but it may be set to progress from the innermost course to the outer courses in order. Also, the progressing direction of the player object 202 is set to be a counterclockwise direction but may be set to a clockwise direction.

In this embodiment, in correspondence with a current position P of the player object 202, the objects, such as the enemy object 210, etc. are appropriately arranged, and therefore, irrespective of the outer courses or the inner courses, the enemy object 210 is set to be arranged (made to appear) at a position Q a predetermined distance away from the current position P of the player object 202.

This is because that in a case that the player object 202 moves, the enemy object 210 is made to appear at a predetermined interval (distance) or timing in both of the outer courses and the inner courses. Accordingly, the predetermined distance d is not a direct distance but a distance (arc-shaped curve distance) in a case that the player object 202 moves along the course.

Furthermore, in this embodiment, a rail R for setting a position Q where the enemy object 210 is made to appear is set on the course, and on the rail R, and a tag (hereinafter, referred to as an “enemy setting tag”) T for arranging the enemy object 210 is set. The enemy setting tag T includes a kind, a total number, formation information and a save flag. In FIG. 11(A) and FIG. 11(B), the rail R is shown by dotted lines, and the enemy setting tag T is shown by an inverted triangle, but these are never displayed on the actual game screen 200. This holds true below.

The kind is information (enemy ID) for identifying (specifying) the enemy object 210. The total number is a maximum number of the enemy objects 210 which is made to appear from the position where the enemy setting tag T is arranged.

The formation information is the kind of the formation formed by the plurality of enemy objects 210 and the number of enemy objects 210 making up of the formation in a case a plurality of enemy objects 210 are made to appear at a time. For example, the kinds of the formation include a vertically-long column (single column or plurality of columns), a horizontally-long column (single column or plurality of columns), etc. Also, in a case that the kind of the formation is not designated, one enemy object 210 is made to appear every predetermined time, for example. Here, when the maximum number of the enemy objects 210 (20, for example) which are made to appear in the virtual game space at a time has already is reached, every time that the enemy object 210 is defeated by the player object 202, one enemy object 210 is made to appear. Or, when the number of enemy objects 210 existing in the virtual game space is equal to or less than a predetermined number, one enemy object 210 is made to appear every predetermined time.

The save flag is a flag for determining whether or not the enemy object 210 is made to appear according to the enemy setting tag T. The save flag is constructed of one bit register. If the save flag is established (turned on), a data value “1” is set to the register, and if the save flag is not established (turned off), a data value “0” is set to the register. For example, when all the enemy objects 210 set to the enemy setting tag T are made to appear, the save flag is turned on. In a case that the save flag on-state is maintained, even if the player object 202 returns to the same place (position P), the enemy object 210 is not made to appear according to the enemy setting tag T. For example, in a case that the boss enemy object 210 is defeated, the save flag on-state is maintained. On the other hand, in a case that the save flag is reset (turned off), when the player object 202 returns to the same place thereafter, the enemy object 210 is made to appear again according to the enemy setting tag T.

As described above, irrespective of outer courses or inner courses, the enemy object 210 is made to appear at a predetermined interval or timing. Thus, in this embodiment, when the enemy object 210 is determined to appear in the area or the range where the enemy object 210 is made to appear (hereinafter, referred to as “area E”), the enemy setting tag T is arranged at a position Q the predetermined distance d away from the current position P of the player object 202 in a moving direction of the player object 202. Here, as described above, the enemy setting tag T is arranged on the rail R set on the course.

It should be noted that the area E where the enemy object 210 is made to appear is the terrain or the place (range) where the enemy object 210 is set to occur and is decided by a two-dimensional range surrounding the terrain or the place (range). For example, a quadrangle range (shown by the alternate long and short dashed lines) surrounding the terrain formed by a plurality of circular ring courses shown in FIG. 11(A) and FIG. 11(B) is the area E in which the enemy object 210 is made to appear. Here, the area F may be set by a circular range surrounding the aforementioned terrain. This holds true for a terrain formed by a spiral curved course described later.

As shown in FIG. 11(A), in a case that the player object 202 exists in the outermost course, from the distance r between the current position P and the central point O defining the terrain or the courses and a predetermined distance d, an angle α (α1 here) is calculated with reference to the current position P of the player object 202. More specifically, this is calculated according to Equation 1.

α=π×d÷2πr=d/(2r) [Equation 1]

Here, the radius r is calculated according to Equation 2. In the Equation 2, three-dimensional coordinates of the point O shall be (x1, y1, z1), and three-dimensional coordinates of the current position P of the player object 202 shall be (x2, y2, z2). In addition, when the angle α is calculated, the height of the terrain is not considered, and thus, the z coordinate is omitted.

r=√{(x1−x2)²+(y1−y2)²} [Equation 2]

In the example shown in FIG. 11(A) (this holds true for FIG. 11(B)), illustration is made as if the player object 202 exists on the rail R, but due to the width of the course, the player object 202 does not always exist on the rail R. Accordingly, when the angle α (=α1) is evaluated, a straight line L2 which forms the angle α1 with a straight line L1 passing through the point O and the current position P is set with the point O as center, and the enemy setting tag T is set to the intersection point between the straight line L2 and the rail R. Here, the straight line L2 is a straight line obtained by rotating the straight line L1 with the point O as center by the angle α1 in the moving direction of the player object 202. This holds true hereunder.

Similarly, as shown in FIG. 11(B), in a case that the player object 202 exists in the course on one inner side of the course in the outermost course as well, the angle α (=α2) is calculated according to the Equation 1 and the Equation 2. When the angle α2 is evaluated, the straight line L2 which forms the angle α2 with the straight line LI passing through the point O and the current position P with the point O as center is set, and the enemy setting tag T is set to the intersection point between the straight line L2 and the rail R.

Here, the rail R is set to each course, and in each of the terrains shown in FIG. 11(A) and FIG. 11(B), the enemy setting tag T is set to the rail R on the course where the player object 202 exists. Accordingly, as in the terrain formed of the spiral curved course as described later, in a case that the height of the course is changed, the height is checked in advance in order to set the enemy setting tag T at an appropriate position.

Furthermore, the reason why the enemy setting tag T is set on the rail R is for saving the enemy objects 210 the inconvenience of being off the course or buried in a wall surface in a case that the enemy objects 210 making a formation are arranged. Accordingly, in a case that the enemy object 210 is made to appear one by one without making a formation, the rail R may not be required. In such a case, an end point (end point opposite to the point O) of a line segment (referred to as “second line segment”, here) which forms the angle α with a line connecting the point O and the current position P of the player object 202 (referred to as “first line segment”, here) with the point O as center is set as a position Q, and the enemy setting tag T is set to the position Q.

Here, the position Q need not be set to the end point of the second line segment, and may be set within a predetermined range with reference to the second line segment. For example, the predetermined range is defined by a circle and a quadrangle with the end point of the second line segment as center. Here, in this embodiment, since the enemy object 210 is arranged (is made to appear) at a predetermined interval or timing, the position where the enemy setting tag T is set within the predetermined range is decided in advance. Furthermore, in a case that the predetermined range is set to be relatively small, even if the enemy setting tag T is set at random within the predetermined range, the enemy object 210 can be made to appear at the predetermined interval or timing. In addition, the position Q may be decided at a position moved away from the end of the second line segment toward the side of the player object 202 or the opposite side by the predetermined distance. That is, the position Q for setting the enemy setting tag T is decided in the position and the range decided based on the second line segment.

Although illustration is omitted, in a case that the moving direction of the player object 202 is a direction opposite to the progressing direction, the enemy setting tag T is set on the rail R such that the enemy object 210 is arranged at the position moved by the predetermined distance d in the direction opposite (in the clockwise direction) to FIG. 11(A) and FIG. 11(B).

Also, in the virtual game of this embodiment, unlike the terrain shown in FIG. 11(A) and FIG. 11(B), the player object 202 may move on the terrain formed by a spiral curved course as shown in a game screen 300 in FIG. 12. In the terrain formed by the spiral curved course displayed on the game screen 300 shown in FIG. 12, the height of the course is progressively lowered toward the center. Information of the height (height information) of the terrain or the course is included in the parameter defining the terrain, and the corresponding data is stored in the main memory (42e, 46) as terrain data 502d (see FIG. 14) as described later. Here, the height information is height information of a certain spot of the terrain or the course, and thus is actually three-dimensional coordinates of a point included in the terrain or the course.

When the terrain formed by the spiral curved course shown in FIG. 12 is seen from directly above, this is shown as shown in FIG. 13(A). Accordingly, in a case that the enemy object 210 is made to appear in the spiral terrain as shown in FIG. 12, the angle α is obtained from the distance (radius r) between the center O of the terrain formed by the spiral curved course and the current position P of the player object 202 and a predetermined distance d as described by using FIG. 11(A) and FIG. 11(B).

Here, as understood from FIG. 13(A) as well, in the terrain formed by the spiral curved course, the course is continuous from the outermost lane to the innermost lane. Thus, depending on the current position P of the player object 202, whether the rail R to which the enemy setting tag T is to be set is inside or outside the current position P may be unclear only from the angle α.

Accordingly, in a case that the height of the course is changed as in the terrain formed by the spiral curved course in this embodiment, the enemy setting tag T is set taking the height of the course in the moving direction of the player object 202 into consideration. More specifically, whether or not the enemy setting tag T is included within the range of a length h upward and downward from the current position P of the player object 202. Hereafter, the determination of the height may be referred to as “height check”.

As described above, in the terrain formed by the spiral curved course shown in FIG. 12, a direction from the outermost lane to the innermost lane is a progressing direction of the player object 202. Accordingly, as shown in FIG. 13(B), in a case that the player object 202 moves in the progressing direction, the enemy setting tag T need to be set on the rail R within the range of the predetermined length h downward from the height of the current position P of the player object 202. Thus, as understood from FIG. 13(B), out of the points A, B, C crossing the straight line L2 shown in FIG. 13(A), the point B and the point C are out of the range of the predetermined length h, and thus, the condition of the height is not satisfied. On the contrary thereto, the point A is within the range of the predetermined length h, and thus, the condition of the height is satisfied. Thus, the point A is decided as a setting position Q of the enemy setting tag T, and the enemy setting tag T is set.

Here, in this embodiment, the enemy setting tag T is set the predetermined distance d ahead in the moving direction of the player object 202. Thus, in the terrain shown in FIG. 13(A) and FIG. 13(B), in a case that the player object 202 moves in a direction opposite to the progressing direction, the enemy setting tag T is set on the rail R within the range of the predetermined length h upward from the height of the current position P of the player object 202.

It should be noted that in this embodiment, the position of the foot of the player object 202 is set to the current position P of the player object 202. However, the predetermined length h for the height check is decided with respect to each terrain in advance.

Although the illustration is omitted, similar to FIG. 11(A) and FIG. 11(B), in the spirally-shaped terrain as well, as the horizontal distance (radius r) between the central point O of the terrain or the spiral course and the current position P of the player object 202 is short (long), the angle α for deciding the position Q where the enemy setting tag T is to be set is made large (small).

Although illustration is omitted, in a case that the height of the terrain formed of the spiral curved course is not changed as in the terrain formed of a plurality of circular courses shown in FIG. 11(A) and FIG. 11(B), out of the points on the rail R crossing with the straight line L2 which forms the angle α with the straight line L1, the point where the enemy setting tag T is to be set is decided as follows. Out of the plurality of points (“candidate points”, here) where the straight line L2 and the rail R set on the course cross, a candidate point for which the length of the line segment (referred to as “third line segment”, here) connecting the central point O and the candidate point is approximately equal to the length of the line segment (referred to as “fourth line segment”, here) connecting the central point O and the player object 202 is decided as a point where the enemy setting tag T is to be set.

For example, in a case that the moving direction of the player object 202 is a direction toward the center of the spiral, the candidate point being the end point of the third line segment slightly shorter than the fourth line segment is selected. On the other hand, in a case that the moving direction of the player object 202 is a direction opposite to the center of the spiral, the candidate point being the end point of the third line segment slightly longer than the fourth line segment is selected.

Furthermore, in this embodiment, after the enemy setting tag T is first set within the area E for making the enemy object 210 appear, the second enemy setting tag T from then on is set at a predetermined timing (set timing). This is because that by adjusting the number of enemy objects 210 existing in the scene or the virtual game space, the processing load of the CPU 40 is restricted (suppressed).

For example, whether the set timing or not is determined whether any one of the following predetermined conditions (set condition) is satisfied. Here, the determination whether the set condition is satisfied or not is performed after the previous enemy setting tag T is set.

(1) A predetermined time t has elapsed.

(2) The player object 202 moves the predetermined distance D or more.

(3) The player object 202 enters the predetermined range within the area E.

(4) The number of enemy objects 210 existing in the current scene or the area E is equal to or less than the predetermined number.

(5) The number of enemy objects 210 that the player object 202 defeats is equal to or more than a predetermined number.

(6) The number of appearing enemy objects 210 is equal to or more than a predetermined number, or the number of times that the enemy objects 210 appear is equal. to or more than a predetermined number.

(7) The life of player objects 202 is equal to or less than a predetermined value.

For example, when the player object 202 moves a predetermined distance D or more, the set condition is satisfied, that is, the set timing has come to thereby set the enemy setting tag T, and therefore, in a case that the kind of the enemy object 210 is set to be different between the enemy setting tags, it is possible to make different enemy objects 210 appear in turn in accordance with the movement of the player object 202.

Here, in a case that two or more of the aforementioned set conditions are satisfied, it may be determined that the set timing has come.

It should be noted that the aforementioned predetermined time t, predetermined distance D, and predetermined number of times are matters to be arbitrarily set by developers and programmers of the virtual game. Furthermore, they may variably be set depending on the progressing state of the virtual game, the game level, etc.

Furthermore, as described above, the set condition is determined in a case that the second enemy setting tag T from then on is set in the area E. Accordingly, in a case that no enemy setting tag T is set within the area E, when the player object 202 enters the area E, it is determined that the set timing has come. Here, when the player object 202 enters the area E to proceed to the predetermined place or enter the predetermined range, it may be determined that the set timing has come.

Also, when the enemy setting tag T is set, the enemy object 210 is arranged at a position Q where the enemy setting tag T is set according to the enemy setting tag T. That is, the enemy object 210 is made to appear. Here, in a case that a plurality of enemy objects 210 makes a formation, the plurality of enemy objects 210 are arranged to make a formation with reference to the position Q.

Thereafter, every predetermined time, one enemy object 210 is arranged at the position Q. Furthermore, in a case of making a formation, a plurality of enemy object 210 are anew arranged to make a formation at a position where the enemy object 210 defeated by the player object 202 is first arranged (is made to appear).

Here, there is no need of being restricted to these methods, but the enemy object 210 is suitably arranged within the maximum number of enemy objects 210 which are made to appear in the scene or the virtual game space.

Furthermore, when a total number of enemy objects 210 indicated by the enemy setting tag T are arranged, the save flag is turned on, and in a case that the on-state is maintained, the enemy object 210 is not arranged at the position Q where the enemy setting tag T is set.

Here, when the enemy object 210 is arranged at the position Q or with reference to the position Q, it moves and attacks the player object 202 according to the program (object controlling program 500e described later).

FIG. 14 is an illustrative view showing one example of a memory map of the main memory (42e or 46) shown in FIG. 2. As shown in FIG. 14, the main memory (42e, 46) includes a program memory area 500 and a data memory area 502. In the program memory area 500, a game program including an image processing program is stored. The game program includes a game main processing program 500a, an image generating program 500b, an image displaying program 500c, an operation input detecting program 500d, an object controlling program 500e, an enemy arrangement position deciding program 500f, etc. For example, the image processing program is made up of the image generating program 500b, the image displaying program 500e, the operation input detecting program 500d, the object controlling program 500e, and the enemy arrangement position deciding program 500f.

The game main processing program 500a is a program for processing a main routine of the virtual game of this embodiment. The image generating program 500b is a program for generating game image data corresponding to the screen (200, 300, etc.) to be displayed on the monitor 34 by utilizing the image data 502b described later. The screen displaying program 500c is a program for outputting (displaying and updating) the game image data generate according to the image generating program 500b on the monitor 34.

The operation input detecting program 500d is a program for detecting controller data to be transmitted from the first controller 22. The object controlling program 500e is a program for moving, etc. the player object 202 according to the controller data, and arranging (making it appear), moving, etc. the non-player object, such as the enemy object 210, etc. independent of the controller data. Here, the object controlling program 500e arranges (makes it appear) the non-player object, such as the enemy object 210, etc. in correspondence with the enemy setting tag T set in the enemy arrangement position deciding program 500f described later.

The enemy arrangement position deciding program 500f is a program for deciding a position where the enemy object 210 is to be arranged (is made to appear) based on the current position P of the player object 202. That is, the enemy arrangement position deciding program 500f decides the position Q where the enemy setting tag T is to be set, and sets the enemy setting tag T at this position Q as described above. Here, the enemy setting tag T to be set is decided depending on the area E (terrain), the course, the game level, etc.

Although illustration is omitted, in the program memory area 500 a sound outputting program, a backup program, etc. are also stored. The sound outputting program is a program for generating and outputting a sound necessary for the game, such as voices (onomatopoeic sound) of the player object 202 and the enemy object 210, a sound effect, music (BGM), etc. The backup program is a program for storing game data (proceeding data, result data) in the flash memory 44 and the memory card according to an instruction from the player and a predetermined game event.

The data memory area 502 is provided with an operation data buffer 502a. Furthermore, in the data memory area 502, image data 502b, current position data 502c, terrain data 502d, rail data 502e, radius data 502f, angle data 502g and enemy setting tag data 502h are stored.

The operation data buffer 502a is a buffer for storing (temporarily storing) controller data from the first controller 22 which is received by the wireless controller module 52 via the antenna 52a. The controller data stored in the operation data buffer 502a is used by the CPU 40, and then deleted (erased).

The image data 502b is data, such as polygon data, texture data, etc. The current position data 502c is data as to the current position P of the player object 202, and is specifically three-dimensional coordinate data of the current position P of the player object 202.

The terrain data 502d is parameter data as to a predetermined terrain, such as terrains formed of the course of the plurality of circular rings and the spiral curved course as described above. More specifically, it is data as to three-dimensional coordinates of the predetermined point (central point O in this embodiment) defining the terrain or the course and each point included in the terrain or the course, and the predetermined length h used for the height check. Here, the terrain data 502d includes parameter data as to each of the plurality of predetermined terrains. Furthermore, in a case that the height of the terrain or the course is not changed, there is no need of performing a height check, and thus, in such a case, the data as to the predetermined length h is not included in the parameter.

The rail data 502e is data as to the rail R set to the terrain corresponding to the terrain data 502d. For example, the rail R is a set of dots, and the rail data 502e is data of three-dimensional coordinates of each dot. Although detailed description is omitted, the rail R is set for each of a plurality of predetermined terrains, and therefore, the rail data 502e includes data as to the plurality of rails R.

The radius data 502f is data as to a distance (radius r) between the central point O of the predetermined terrain and the current position P of the player object 202 which is to be calculated in a case that a position for setting the enemy setting tag T is decided in the predetermined terrain

The angle data 502g is data as to the angle α formed between the straight line L1 passing through the central point O of the predetermined terrain and the current position P of the player object 202 and the straight line L2 set with respect to the straight line L1 which is to be calculated in a case that a position for setting the enemy setting tag T is decided in the predetermined terrain.

The enemy setting tag data 502h is data as to the enemy setting tag T currently set. Accordingly, in a case that a plurality of enemy setting tags T are set within the virtual game space, data as to each of the enemy setting tags T is stored.

Although illustration is omitted, in the data memory area 502, sound data, etc. is also stored, and a flag and a counter (timer) necessary for the game processing are also provided.

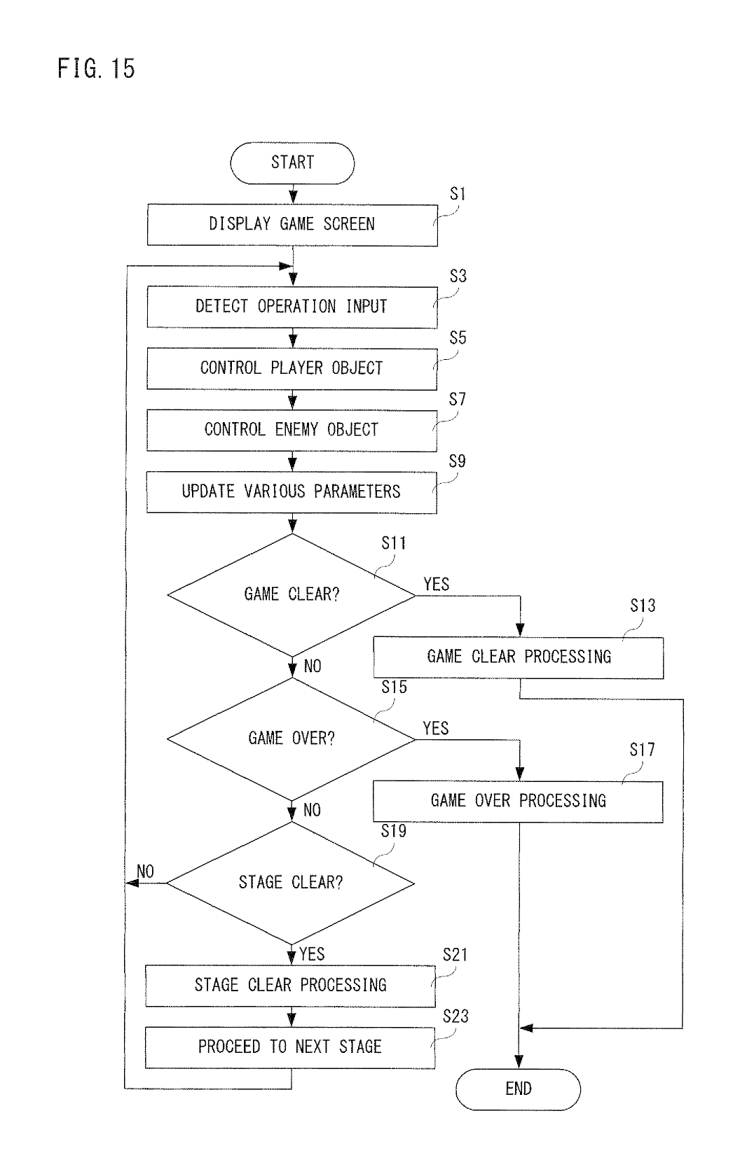

More specifically, the CPU 40 shown in FIG. 2 executes game entire processing shown in FIG. 15. When starting the game entire processing, the CPU 40 displays a game screen in a step S1. Here, in a case that the virtual game is started from the first, the CPU 40 displays an initial game screen of the virtual game on the monitor 34. Alternatively, in a case that the virtual game is started from the continuation of the previous play, the CPU 40 displays a game screen for starting the virtual game from the continuation of the previous play on the monitor 34.

In a next step S3, an operation input is detected. Here, the CPU 40 stores the controller data received via the antenna 52a and the wireless controller 52 in the operation data buffer 502a within the main memory (42e, 46). In a succeeding step S5, the player object 202 is controlled. Here, the CPU 40 moves the player object 202 and makes the player object 202 perform a predetermined action according to the controller data stored in the operation data buffer 502a. It should be noted that in a case that the player object 202 is moved, the CPU 40 stores three-dimensional coordinate data of the current position P after movement as current position data 502c in the data memory area 502. That is, the current position data 502c is updated.

In a next step S7, the enemy object 210 is controlled. Here, the CPU 40 arranges the enemy object 210 (makes it appear) according to the enemy setting tag T. Furthermore, the CPU 40 moves the enemy object 210, and makes the enemy object 210 perform a predetermined action according to the game program.

Although a detailed description is omitted, depending on the processing in the steps S5 and S7, the player object 202 and the enemy object 210 encounter and fight with each other. Furthermore, the game screen is updated by these processing. In addition, although illustration is omitted, if the player object 202 obtains an item by the processing in the step S5, the item is added as a possessed item, and when the item is used, the item is erased from the possessed item.

In a next step S9, various parameters are updated. Here, the CPU 40 changes (increases or decreases) the life of the player object 202 and the enemy object 210, changes (increases) the level of the player object 202, changes (decreases or increases) the offensive power and the defensive power of the player object 202.

Succeedingly, in a step S11, it is determined whether or not the game is to be cleared. For example, the CPU 40 determines whether or not the player or the player object 202 clears all the stages. If “YES” in the step S11, that is, if the game is to be cleared, game clear processing is executed in a step S13 to thereby end the game entire processing. For example, in the step S13, the CPU 40 displays a game screen representing a game clear on the monitor 34, and outputs sound or music representing it from the speaker 34a.

On the other hand, if “NO” in the step S11, that is, if the game is not cleared, it is determined whether or not the game is over in a step S15. For example, the CPU 40 determines whether or not the player object 202 is defeated based on the fact that the life of the player object 202 is equal to or less than 0. If “YES” in the step S5, that is, if the game is over, game over processing is executed in a step S17, and the game entire processing is ended. For example, in the step S17, the CPU 40 displays a game screen representing game over on the monitor 34, and outputs sound or music representing it from the speaker 34a.

Here, in a case that the game is cleared or the game is over, the game entire processing is ended, but the game entire processing may be ended according to an operation by the player. Although illustration is omitted, according to an operation by the player and a predetermined game event, backup processing of the game data may be executed.

Also, if “NO” in the step S15, that is, if the game is not over, it is determined whether or not the stage is cleared in a step S19. For example, the CPU 40 determines whether or not the player object 202 defeats the enemy object 202 being a boss in the current stage.

If “NO” in the step S19, that is, if the stage is not cleared, the process returns to the step S3 as it is. On the other hand, if “YES” in the step S19, that is, if the stage is to be cleared, stage clear processing is executed in a step S21. Here, the CPU 40 displays a game screen representing stage clear on the monitor 34, or outputs sound or music representing it from the speaker 34a.

In a next step S23, the process proceeds to a next stage, and the process returns to the step S3. For example, in the step S23, the CPU 40 moves the player object 202 to an initial position (start point) of the next stage.

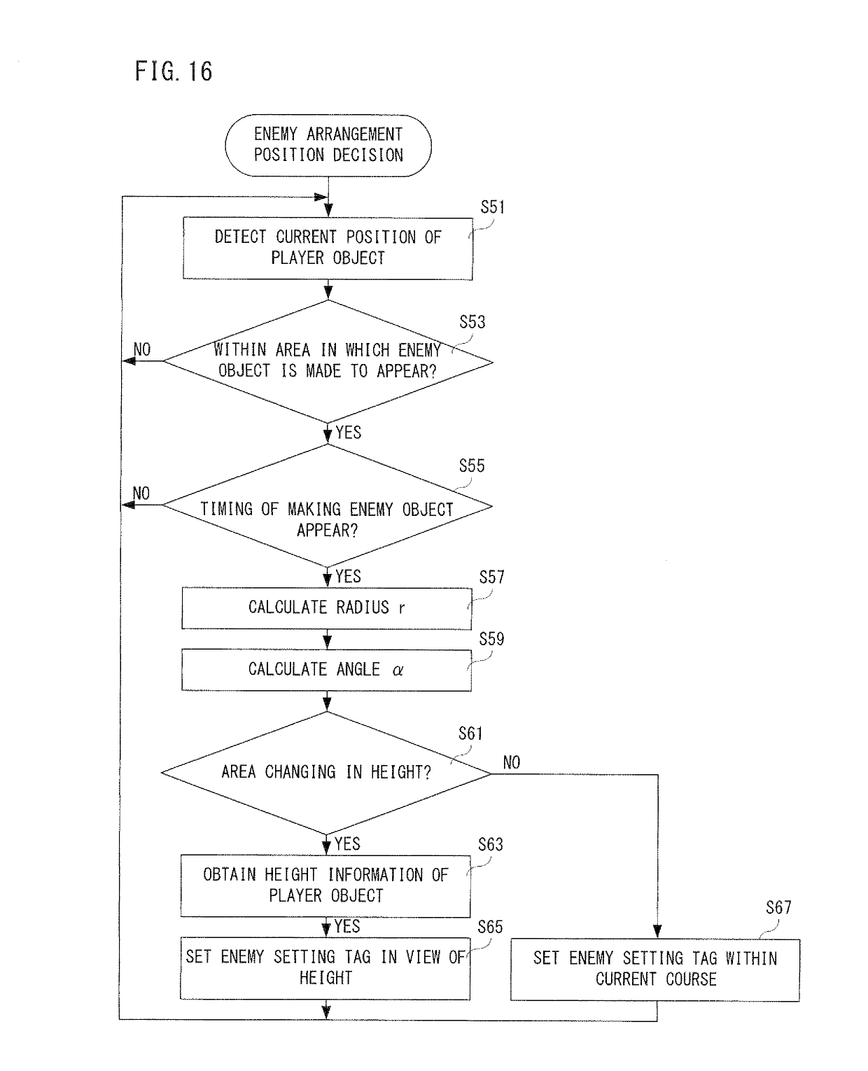

FIG. 16 shows a flowchart showing enemy arrangement position deciding processing by the CPU 40 shown in FIG. 2. The CPU 40 executes the enemy arrangement position deciding processing in parallel in a task different from the game entire processing. Here, the enemy arrangement position deciding processing is started when the game entire processing is started.

As shown in FIG. 16, when starting the enemy arrangement position deciding processing, the CPU 40 detects a current position of the player object 202 in a step S51. Here, the CPU 40 detects three-dimensional coordinates of the current position P of the player object 202 corresponding to the current position data 502c with reference to the data memory area 502.

In a succeeding step S53, it is determined whether or not the current position P of the player object 202 is within the area E in which the enemy object 210 is made to appear. That is, the CPU 40 determines whether or not the current position P is within the area E of the terrain stored in the terrain data 502d. Here, whether or not the current position P is within the area E is determined by the two-dimensional coordinates (XY coordinates) exclusive of the height information (Z coordinate) out of the three-dimensional coordinates of the current position P.

If “NO” in the step S53, that is, if the current position P of the player object 202 is out of the area E in which the enemy object 210 is made to appear, the process returns to the step S51 as it is. On the other hand, if “YES” in the step S53, that is, if the current position P of the player object 202 is within the area E in which the enemy object 210 is made to appear, it is determined whether or not a timing of making the enemy object 210 appear has come in a step S55. The determination is as described above.

If “NO” in the step S55, that is, if a timing making the enemy object 210 appear has not come, the process returns to the step S51 as it is. On the other hand, if “YES” in the step S55, that is, if a timing making the enemy object 210 appear has come, a radius r is calculated in a step S57. Here, the CPU 40 calculates the horizontal distance between the central point O of the terrain and the current position P of the player object 202 according to the Equation 2. In a next step S59, an angle α is calculated. Here, the CPU 40 obtains the angle α according to the Equation 1 by using the radius r previously calculated and the predetermined distance d.

Then, in a step S61, it is determined whether or not the terrain is the area E changing in height. Here, the CPU 40 determines whether or not the terrain is the area E changing in height with reference to the height information included in the terrain data 502d stored in the data memory area 502. Or, the CPU 40 determines whether t the terrain is the area E changing in height or not depending on whether the data of the predetermined length h is included in the terrain data 502d.

If “YES” in the step S61, that is, if the terrain is an area E changing in height, the height information (Z coordinate) of the player object 202 is obtained in a step S63, the enemy setting tag T is set in view of the height in a step S65, and the process returns to the step S51. In the step S65, the CPU 40 sets the straight line L2 which forms the angle α with the straight line L1. Next, the point on the rail R within the range of the predetermined length h out of the points where the straight line L2 and the rail R cross is decided as a position Q with reference to the height of the current position P of the player object 202. Then, the enemy setting tag T is set to this position Q.

On the other hand, if “NO” in the step S61, that is, if the terrain is not the area E changing in height, the enemy setting tag T is set within the current course in a step S67, and the process returns to the step S51. In the step S67, the CPU 40 sets the straight line L2 which forms the angle α with the straight line L1. Next, out of the points where the straight line L2 and the rail R cross, the point on the rail R set on the course including the current position P of the player object 202 is decided as a position Q. Then, the enemy setting tag T is set to the position Q.

Here, as described above, the contents of the set enemy setting tag T are decided depending on the area E (terrain), the course, the game level, etc.

According to this embodiment, on the basis of the referential position, such as a current position of the player object and the central point of the predetermined terrain, the enemy object is arranged at a position predetermined distance away from the current position of the player object along the curve like an arc, and therefore, in a case that the player object moves along the circular or spiral curved course, etc., the enemy object can be made to appear at equal intervals or timing by a simple method. That is, on the basis of the referential position on the course and the parameters defined in the terrain set in the virtual space, the arrangement position of the object can suitably be decided depending on the situations.

Additionally, in this embodiment, the description is made on a case that the enemy object is arranged, but by the same method, another object (non-player object) like a predetermined item can also be arranged.

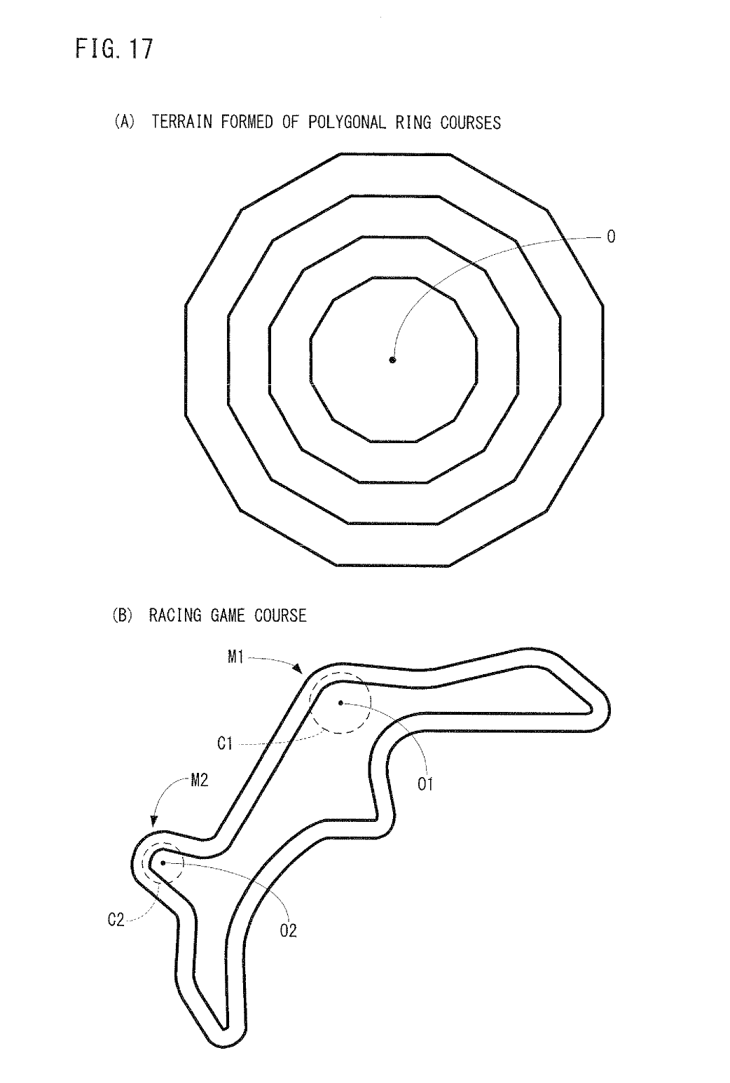

Furthermore, in this embodiment, the enemy setting tag T is set in a smooth curved course like the terrain formed of a plurality of circular ring courses or the spiral curved course, but as shown in FIG. 17(A), in the terrain formed of plurality of polygonal ring courses different in size with a common central point O as well, the enemy setting tag T can be set according to a similar method. Here, in FIG. 17(A), as an example of a polygon, a regular dodecagon is shown, but there is no need of being restricted thereto. Although illustration is omitted, in the terrain as shown in FIG. 17(A) also, the rail R is set. In the terrain formed of regular polygonal ring courses, a similar regular polygonal rail R can be set, and a circular rail R can be set.

Additionally, in this embodiment, a description is made on the course in which circles different in size (radius) are piled up as in the terrain formed of a plurality of circular ring courses and a spiral curved course, but there is no need of being restricted thereto. For example, in a course of a racing game as well shown in FIG. 17(B), a similar method can be used. More specifically, as shown in FIG. 17(B), at a corner M1, on the basis of a central point O1 of a circle C1 defining the corner Ml and the current position of the player object (although omitted in the drawing), an arrangement position for setting the enemy setting tag (object arrangement position) is decided. Furthermore, at a corner M2, on the basis of a central point O2 of a circle C2 defining the corner M2 and the current position of the player object, an arrangement position of the object is decided. Although the illustration is omitted, this holds true for another corner. Furthermore, at the course of the racing game, the rail R is set, and on the rail R, the enemy setting tag is set.

In the course shown in FIG. 17(B), in a case that there is no place where the courses itself are piled up on each other, but the courses cross or piled up on each other in a three-dimensional manner at corners, for example, the height is also taken into consideration as in the aforementioned embodiment.

It should be noted that this is not an essential content of the present embodiment, but in the racing game, as a determination whether or not a timing of making the enemy object appear has come, it is determined whether or not the speed of the player object is equal to or more than a predetermined speed, for example. Thus, in a case of the player object driving at a speed equal to or more than the predetermined speed, for example, the enemy object (obstacle object, such as a vehicle being one lap behind) is made to appear, and in a case of the player object driving at a speed less than the predetermined speed, the enemy object may not be made to appear. On the contrary thereto, in a case of the player object driving at a speed equal to or more than the predetermined speed, a predetermined item (help item such as speed up or invincible state, etc.) is not made to appear, but in a case of the player object driving at a speed less than the predetermined speed, the predetermined item can be made to appear.

Furthermore, in this embodiment, on the basis of the referential position like the current position of the player object and the central point of the predetermined terrain, the enemy object is arranged at a position predetermined distance away from the current position of the player object along the curve like an arc. For example, in a case that the position where the enemy object is arranged (made to appear) is decided in advance, a range decided based on the position where the enemy object is arranged (made to appear) and the position the predetermined distance away along the course is set on the course, and when the player object enters the predetermined range, the enemy object may be made to appear, whereby the enemy object may be made to appear at equal intervals or timing in a case that the player object moves as in the above-described embodiment.

Also, in this embodiment, the gyro unit is configured to be detachably attached to the first controller, but the gyro unit may be provided in the first controller as one unit. Alternatively, only the gyro sensor may be contained in the first controller.

Furthermore, in this embodiment, a description is made on a case that a console-type game apparatus is used, but this can be applied to various electronic appliances having a function of displaying images, such as a hand-held type game apparatus including a display and a controller as one unit, a personal computer, a PDA, a cellular phone, etc.

In addition, the present embodiment can be applied to an image processing system in which each processing (programs 500b-500f) for image processing is distributedly performed by a plurality of computers, etc.

While certain example systems, methods, storage media, devices and apparatuses have been described herein, it is to be understood that the appended claims are not to be limited to the systems, methods, storage media, devices and apparatuses disclosed, but on the contrary, are intended to cover various modifications and equivalent arrangements included within the spirit and scope of the appended claims.

What is claimed is:

1. A storage medium storing an image processing program,
said image processing program causes a computer of an image processing apparatus to function as following means:
an image outputter which outputs an image obtained by imaging a virtual space to which a terrain is set with a virtual camera;
an arrangement position decider which decides an arrangement position of an object on the basis of a parameter which is defined in said terrain and a predetermined referential position; and
an object arranger which arranges said object at the arrangement position decided by said arrangement position decider.

2. A storage medium according to claim 1, wherein
said parameter includes a predetermined point of said terrain, and
said arrangement position decider decides a position specified based on a length of a line segment connecting said predetermined point and said referential position as the arrangement position of said object.

3. A storage medium according to claim 2, wherein
said arrangement position decider decides, as the arrangement position f said object, a position on another line set so as to form with said line segment an angle decided in correspondence with the length of said line segment with said predetermined point as center.

4. A storage medium according to claim 2, wherein
said arrangement position decider decides, as the arrangement position f said object, an end point of another line set so as to form with said line segment an angle decided in correspondence with a length of said line segment with said predetermined point as center.

5. A storage medium according to claim 3, wherein said angle is decreased as the length of said line segment is increased.

6. A storage medium according to claim 2, wherein said parameter further includes a height of said terrain.

7. A storage medium according to claim 6, wherein
said arrangement position decider decides a position of the terrain with the height having a predetermined relationship with the height at said referential position of the terrain as the arrangement position of said object.

8. A storage medium according to claim 2, wherein
said terrain includes a curved course,
the predetermined point of said terrain is a center point for defining said curved course, and
said referential position is set on said curved course.

9. A storage medium according to claim 8, wherein said terrain includes a spirally-formed curved course.

10. A storage medium according to claim 9, wherein said spirally-formed curved course changes in height toward a center.

11. A storage medium according to claim 1, wherein
said object is a non-player object,
said referential position is a current position of a player object, and
said arrangement position decider decides an arrangement position of said non-player object at a position a predetermined interval away along a current moving direction of said player object.

12. An image processing apparatus, comprising:
an image outputter which outputs an image obtained by imaging a virtual space to which a terrain is set with a virtual camera;
an arrangement position decider which decides an arrangement position of an object on the basis of a parameter which is defined in said terrain and a predetermined referential position; and
an object arranger which arranges said object at the arrangement position decided by said arrangement position decider.

13. An image processing method of an image processing apparatus, comprising following steps of:
(a) outputting an image obtained by imaging a virtual space to which a terrain is set with a virtual camera;
(b) deciding an arrangement position of an object on the basis of a parameter which is defined in said terrain and a predetermined referential position; and
(c) arranging said object at the arrangement position decided by said step (b).

14. An image processing system comprising:
an image outputter which outputs an image obtained by imaging a virtual space to which a terrain is set with a virtual camera;
an arrangement position decider which decides an arrangement position of an object on the basis of a parameter which is defined in said terrain and a predetermined referential position; and
an object arranger which arranges said object at the arrangement position decided by said arrangement position decider.
